(19) United States
(12) Patent Application Publication
(10) Pub. No.: US 2021/0305868 A1
(43) Pub. Date: Sep. 30, 2021

(54) ROTARY ELECTRIC MACHINE

(71) Applicant: AISIN SEIKI KABUSHIKI KAISHA, Kariya-shi (JP)

(72) Inventor: Masafumi SAKUMA, Kariya-shi (JP)

(73) Assignee: AISIN SEIKI KABUSHIKI KAISHA, Kariya-shi (JP)

(21) Appl. No.: 17/208,353

(22) Filed: Mar. 22, 2021

(30) Foreign Application Priority Data
Mar. 27, 2020 (JP) 2020-058642

(51) Int. Cl. H02K 3/28; H02K 1/16; H02K 3/14

(52) U.S. Cl. CPC H02K 3/28; H02K 2213/03; H02K 3/14; H02K 1/165

(57) ABSTRACT

A rotary electric machine includes a stator having slots, and a rotor having magnetic poles. When an irreducible fraction expression of the number of slots per pole and phase is set as (a+b/c), the coil for a laps is configured by an adjacent pole coil group, and the coil of a (a+1)th lap is configured by a continuous-pole coil group. In the adjacent pole coil group, the pole coil that is not interposed between adjacent-pole-connection same layer connection portions and the pole coil interposed therebetween are alternately arranged. The continuous-pole coil group is configured only by the pole coil that is not interposed therebetween when the number of blanks is all odd, and by the pole coil that is not interposed therebetween and the pole coil interposed therebetween when the number of blanks is all even or when odd and even numbers are mixed as the number of blanks.

### CROSS REFERENCE TO RELATED APPLICATIONS

This application is based on and claims priority under 35 U.S.C. § 119 to Japanese Patent Application No. 2020-58642, filed on Mar. 27, 2020, the entire content of which is incorporated herein by reference.

### TECHNICAL FIELD

This disclosure relates to a rotary electric machine including a stator having a plurality of slots accommodating a coil made of a segment conductor and a rotor facing the stator and having a plurality of magnetic poles.

### BACKGROUND DISCUSSION

In the related art, a rotary electric machine as follows is known (for example, see JP 2012-16195 A and JP 2014-103707 A). The rotary electric machine includes a coil having a heavy winding configuration made of segment conductors and has an integer slot configuration in which the number of slots per pole and phase, which is obtained by dividing the number of slots of a stator by the number of phases and the number of magnetic poles of a rotor, is a natural number.

The rotary electric machine disclosed in JP 2012-16195 A is formed by arranging 2n unit coils having a distributed winding configuration of being wound at predetermined slot intervals in a circumferential direction of the stator. One of two slots into which a first unit coil is inserted is the same as one of two slots into which an n-th unit coil is inserted. One of two slots into which a (n+1)th unit coil is inserted is the same as one of two slots into which a 2n-th unit coil is inserted. JP 2012-16195 A discloses that, with such a configuration, it is possible to reduce the potential difference between different unit coils arranged in the same slot to about the half the in-phase potential difference.

The rotary electric machine disclosed in JP 2014-103707 A uses a U-shaped conductor segment as a unit coil having a distributed winding configuration of being wound at predetermined slot intervals in the circumferential direction of the stator. The rotary electric machine has a shape in which the leg portion of the conductor segment is bent in a radial offset state. The leg portions of conductor segments adjacent to each other in the radial direction are electrically connected to each other. JP 2014-103707 A discloses that, with such a configuration, the conductor segment at the start of winding and the conductor segment at the end of the winding are arranged in the same slot without being adjacent to each other, and thus it is possible to reduce the maximum potential difference between the conductor segments.

A rotary electric machine that includes a coil made of segment conductors and has a fractional slot configuration in which, when the number of slots per pole and phase is expressed by an irreducible fraction, the denominator is equal to or more than 2 is known (for example, see JP 2008-172926 A). The technique disclosed in JP 2008-172926 A realizes a rotary electric machine having a fractional slot configuration in which segment conductors having different phases are mixed in one slot by forming the segment conductors in a wave winding configuration.

A rotary electric machine having a fractional slot configuration is useful because it is possible to realize the better torque ripple characteristics with a smaller number of slots than a rotary electric machine having an integer slot configuration. However, the technique disclosed in JP 2012-16195 A and JP 2014-103707 A are rotary electric machines having an integer slot configuration. Thus, it is not possible to apply the techniques to rotary electric machines having a fractional slot configuration. Although the technique disclosed in JP 2008-172926 A is a rotary electric machine having a fractional slot configuration, this technique adopts a wave winding configuration in which a short-section pitch and a long-section pitch are repeated. Thus, the total coil length is longer than the heavy winding configuration when the short-section pitch is mainly used. The manufacturing cost also increases.

Therefore, it is desired to realize a rotary electric machine having a fractional slot configuration using a segment conductor, with a heavy winding configuration.

A need thus exists for a rotary electric machine which is not susceptible to the drawback mentioned above.

### SUMMARY

According to an aspect of this disclosure, a rotary electric machine includes a stator that has a plurality of slots accommodating a coil having a heavy winding configuration made of a segment conductor, and a rotor that faces the stator and has a plurality of magnetic poles, and has a fractional slot configuration in which the number of slots per pole and phase, which is obtained by dividing the number of the slots of the stator by the number of phases and the number of the magnetic poles of the rotor, is more than ½, and a denominator is equal to or more than 2 in an irreducible fraction expression. When the irreducible fraction expression of the number of slots per pole and phase is set as (a+b/c) where a indicates zero or a positive integer, and b and c indicate a positive integer and b<c, the coil for a laps is configured by an adjacent pole coil group in which pole coils adjacent to each other in a circumferential direction are electrically and sequentially connected to each other while the pole coils are arranged to be adjacent to each other over an entire circumference of the stator, the pole coils of which the number is equal to the number of magnetic poles of the rotor, the coil of a (a+1)th lap is configured by a continuous-pole coil group in which a continuous-pole coil is arranged in a range obtained by equally dividing the entire circumference by the number of magnetic poles/c, and the continuous-pole coils of the number of magnetic poles/c, which are adjacent to each other in the circumferential direction are sequentially and electrically connected to each other and wound, the continuous-pole coil in which b pieces of pole coils and a pole coil missing portion are adjacent to each other in no particular order, and the pole coils that are closest to each other in the circumferential direction are electrically connected, and the pole coil missing portion being made of blanks corresponding to (c−b) pieces of the pole coils, in the adjacent pole coil group, the pole coil that is not interposed between a pair of adjacent-pole-connection same layer connection portions that electrically connect the coils that are arranged on the outermost radial side and the innermost radial side of the slot and adjacent to each other, and the pole coil interposed between the pair of adjacent-pole-connection same layer connection portions are alternately arranged in the circumferential direction, and the continuous-pole coil group is configured only by the pole coil that is not interposed between the pair of adjacent-pole-connection same layer connection portions when the number of blanks between the pole coils is all odd, and configured by the pole coil that is not interposed between the pair of adjacent-pole-connection same layer connection portions and the pole coil interposed between the pair of adjacent-pole-connection same layer connection portions when the number of blanks between the pole coils is all even (including zero) or when an odd number and an even number (including zero) are mixed as the number of blanks between the pole coils, where the a laps are made in the same direction.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a partially enlarged cross-sectional view of a rotary electric machine;

FIG. 2 is a schematic diagram illustrating an example of a phase arrangement of 8 poles and 60 slots;

FIG. 3 is a schematic diagram illustrating a winding configuration of a first lap in a U-phase of 8 poles and 60 slots;

FIG. 4 is a schematic diagram illustrating a winding configuration of a second lap in the U-phase of 8 poles and 60 slots;

FIG. 5 is a schematic diagram illustrating a winding configuration of a third lap in the U-phase of 8 poles and 60 slots;

FIG. 6 is a schematic diagram illustrating an overall winding configuration of 8 poles and 60 slots;

FIG. 7 is a schematic diagram illustrating a unit coil of an adjacent-pole-connection same layer connection portion on the outermost radial side;

FIG. 8 is a schematic diagram illustrating a unit coil of a pole coil;

FIG. 9 is a schematic diagram illustrating a unit coil of the adjacent-pole-connection same layer connection portion on the innermost radial side;

FIG. 10 is a schematic diagram illustrating a unit coil of a continuous-pole coil connection portion;

FIG. 11 is a schematic diagram illustrating a winding configuration in a U-phase of 8 poles and 36 slots;

FIG. 12 is a schematic diagram illustrating a winding configuration in a U-phase of 8 poles and 30 slots;

FIG. 13 is a schematic diagram illustrating a winding configuration in a U-phase of 10 poles and 36 slots;

FIG. 14 is a schematic diagram illustrating a winding configuration in a U-phase of 10 poles and 42 slots;

FIG. 15 is a schematic diagram illustrating a winding configuration in a U-phase of 8 poles and 42 slots;

FIG. 16 is a schematic diagram illustrating a winding configuration in a U-phase of 8 poles and 18 slots;

FIG. 17 is a schematic diagram illustrating a winding configuration of a short-section pitch in the U-phase of 8 poles and 60 slots;

FIG. 18 is a schematic diagram illustrating a winding configuration of a long-section pitch in the U-phase of 8 poles and 60 slots;

FIG. 19 is a schematic diagram illustrating a modification example of a phase starting end position of FIG. 15; and

FIG. 20 is a schematic diagram illustrating another modification example of the phase starting end position of FIG. 15.

### DETAILED DESCRIPTION

Hereinafter, embodiments of a rotary electric machine according to this disclosure will be described with reference to the drawings. In this embodiment, a three-phase AC synchronous motor (referred to as a motor M below) will be described as an example of the rotary electric machine. The present disclosure is not limited to the following embodiments, and various modifications can be made without departing from the gist thereof.

Basic Configuration

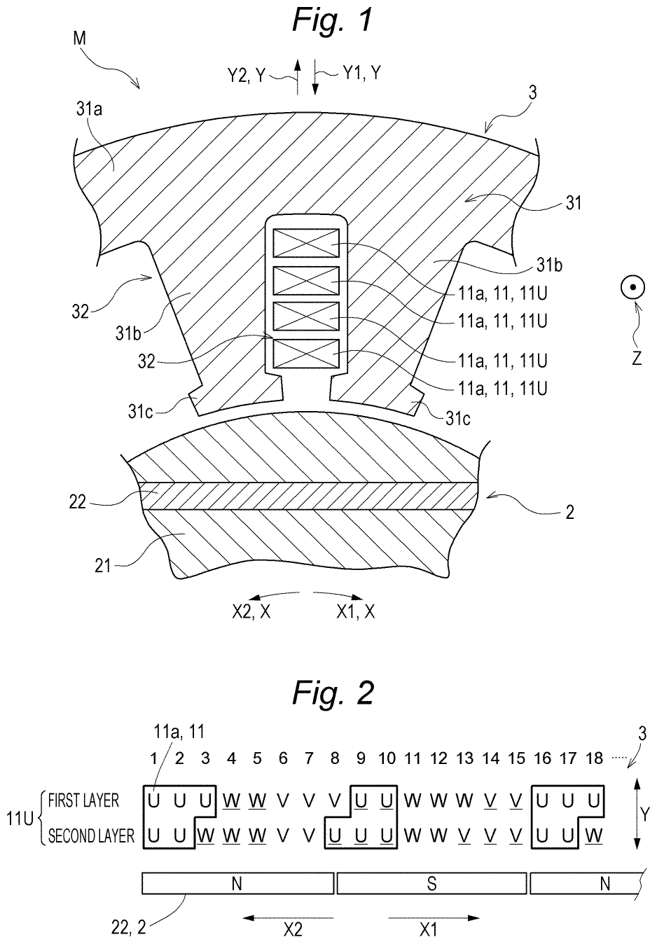

As illustrated in FIG. 1, the motor M includes a stator 3 and a rotor 2. The stator 3 has a plurality of slots 32 accommodating coil sides 11a of a plurality of unit coils (example of coils) 11 configured by segment conductors (referred to as a “winding” below). The rotor 2 faces the stator 3 and includes a plurality of permanent magnets (example of magnetic poles) 22. In the following description, a rotation direction or a reverse rotation direction of the rotor 2 is referred to as a circumferential direction X, a radial direction of the rotor 2 is referred to as a radial direction Y, and a direction parallel to a rotation shaft core of the rotor 2 is referred to as an axial direction (orthogonal direction) Z. In the circumferential direction X, a direction in which the rotor 2 rotates is referred to as a rotation direction X1, and the opposite direction is referred to as a reverse rotation direction X2. In the radial direction Y, a direction from the stator 3 to the rotor 2 (direction toward an opening of the slot 32) is referred to as a radially-inward direction Y1, and a direction from the rotor 2 to the stator 3 is referred to as a radially-outward direction Y2 (direction toward the bottom of the slot 32).

The stator 3 includes a tubular stator core 31. The stator core 31 is formed by stacking a plurality of magnetic steel plates. The stator core 31 includes a yoke portion 31a, a plurality of teeth portions 31b, and a flange portion 31c. The yoke portion is formed in an annular shape on the radially-outward direction Y2 side. The teeth portion protrudes from the yoke portion 31a in the radially-inward direction Y1. The flange portion 31c is arranged at protruding ends of each of the plurality of teeth portions 31b in the circumferential direction X. The slot 32 that accommodates the coil side 11a of the unit coil 11 configured by windings is formed between the teeth portions 31b adjacent to each other. The plurality of slots 32 of which the number is equal to the number of the plurality of teeth portions 31b are provided.

The rotor 2 includes a tubular rotor core 21 formed by stacking a plurality of magnetic steel plates, and a plurality of permanent magnets 22 buried in the rotor core 21. The rotor core 21 is supported by a shaft member (not illustrated) and is configured so that the rotor 2 is rotatable relative to the stator 3 in the rotation direction X1 and the reverse rotation direction X2. The permanent magnet 22 is configured of a rare earth magnet or the like, and N poles and S poles are alternately arranged in the circumferential direction X. The outer circumferential surfaces of the plurality of permanent magnets 22 may be exposed from the rotor core 21.

In this embodiment, the motor M is configured by fractional slots in which a value (referred to as the number of slots per pole and phase or Nspp below) obtained by dividing the number of slots 32 of the stator 3 by the number of phases (three phases in this embodiment) and the number of magnetic poles of the rotor 2 is more than ½, and the denominator is equal to or more than 2 when the number of slots per pole and phase is expressed by an irreducible fraction. The number of slots per pole and phase is expressed below as a+b/c in a mixed irreducible fraction expression (a indicates an integer portion, b/c indicates the irreducible fraction portion and satisfies b<c, where a is zero or a positive integer, and b and c are positive integers). For example, in a motor M of 8 poles and 60 slots, the number of slots per pole and phase is 5/2 (a=2, b=1, c=2).

The winding wound around the plurality of slots 32 is configured by, for example, a segment conductor in which a copper wire is coated with an insulating layer. For this winding, a square wire having a rectangular cross section, a round wire having a circular cross section, and various conductive wires having a polygonal cross section are used. In this embodiment, a winding method of the winding around the slots 32 is configured by heavy winding.

As illustrated in FIG. 1, in each of the coils of phases (U-phase, V-phase, and W-phase), a plurality of unit coils 11 are stacked in the slot 32 in the radial direction Y. The fractional slot includes a plurality of sets of two-layer units 11U configured by coil sides 11a of unit coils 11 having two layers in which two unit coils 11 are stacked (for example, four sets in which one layer to two layers in FIG. 2 are repeated in the radial direction Y). In this embodiment, regarding the coil of each phase in this embodiment, a plurality of unit coils 11 are stacked in the radial direction Y to form a plurality of layers and then are accommodated in the slot 32. The three-phase coils are electrically connected by Y connection. The three-phase coils may be electrically connected by A connection, and the connection is not particularly limited. The “layers” having the same number are connected in the rotation direction X1 of the rotor 2 at the same position in a depth direction of the slot 32 (radial direction Y).

In the case of heavy winding in a fractional slot, the coil pitch is preferably the closest integer to the number of slots per pole, which is obtained by dividing the number of slots 32 of the stator 3 by the number of magnetic poles of the rotor 2. For example, in the case of a motor M of 8 poles and 60 slots (the number of slots per pole is 7.5), the coil pitch is 7 slots (short-section winding) as a short-section pitch or 8 slots (long winding) as a long-section pitch.

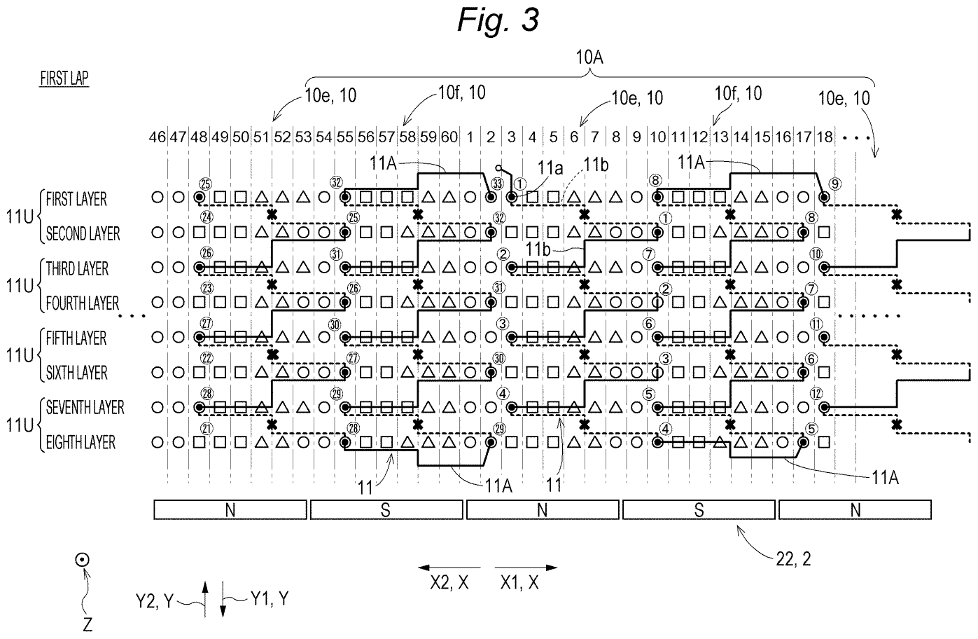

FIG. 2 illustrates an example of a magnetic-pole facing state between the phase arrangement of the coil sides 11a of windings wound around a plurality of slots 32 and magnetic poles (N pole and S pole) of a pair of rotors 2, according to this embodiment. FIG. 2 illustrates FIG. 1 in a straight line for convenience (the inner radial side is expanded for convenience). Illustrations of the yoke portion 31a, the teeth portion 31b, and the windings are omitted. Serial numbers described on the upper part of FIG. 2 indicate the slot numbers of the slots 32. The U-phase coil, the V-phase coil, and the W-phase coil are shifted from each other by the phase of 120° as an electrical angle in the rotation direction X1 in this order. Since each phase (U phase, V phase, W phase) has the same phase arrangement except for the phase shift, the U-phase coil will be described below as a representative. In FIG. 2, the notation of “U” and the notation of “U” underlined indicate that the current directions are opposite to each other. The same notation indicates that the coil side 11a has the same current direction. Layers are expressed as a first layer, a second layer, and so on in order from the coil side 11a located in the most radially-outward direction Y2 in the radial direction Y to the coil side 11a in the radially-inward direction Y1. That is, as the layer-phase band arrangement of the slot 32 in the radial direction Y, the bottom layer of the slot 32 is set to 1, and the layers are counted in ascending order toward the opening portion of the slot 32 (the same is applied below). At this time, the even-numbered layer of the slot 32 is configured by moving an odd-numbered layer of the slot 32 in the circumferential direction X by a predetermined slot number (here, 7 or 8) configured by an integer closest to the number of slots per pole, which is obtained by multiplying the number Nspp of slots per pole and phase by the number (3) of phases. Here, when c=2, the movement direction of the even-numbered layer by the predetermined slot number with respect to the odd-numbered layer is either the rotation direction X1 or the reverse rotation direction X2. The layer-phase band arrangement of even-numbered layers or the layer-phase band arrangement of the odd-numbered layers has the same configuration in the circumferential direction X (see FIGS. 3 to 6 described later).

In this embodiment, in the case of a motor M of 8 poles and 60 slots, a first phase band group and a second phase band group are alternately arranged in the circumferential direction X (see FIG. 2, but FIG. 2 illustrates only a first layer and a second layer). The first phase band group includes four sets of two-layer units 11U (from a first layer to an eighth layer) configured by coil sides 11a of a two-layer unit coil 11 in which three coil sides 11a for the first layer and two coil sides 11a for the second layer are stacked. The second phase band group includes four sets of two-layer units 11U (from a first layer to an eighth layer) configured by coil sides 11a of a two-layer unit coil 11 in which two coil sides 11a for the first layer and three coil sides 11a for the second layer are stacked.

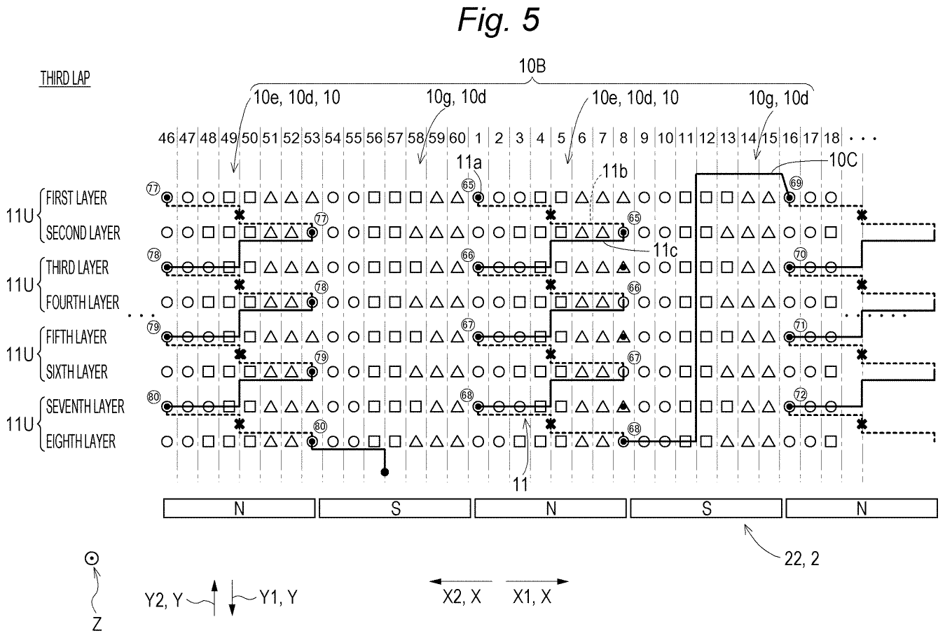

FIGS. 3 to 6 illustrate heavy winding of the U phase, as an example of the winding method for the winding around the slot 32 in the case of a motor M of 8 poles and 60 slots (Nspp=2.5, a=2, b=1, c=2). Here, FIGS. 3 to 6 illustrate a case in which the coil side 11a made of one segment conductor is accommodated in one layer, eight coil sides 11a are accommodated in one slot, and all in-phase unit coils are connected in a series, and thus the number of series turns of one phase is 80. The numbers in the upper part in FIGS. 3 to 6 indicate the slot numbers. The circled numbers in FIGS. 3 to 6 indicate the winding order of each turn. The white circle (see FIG. 3) in FIGS. 3 to 6 connected to the turn having the winding order No. 1 indicates a winding starting end. The black circle (see FIG. 5) in FIGS. 3 to 6 connected to the turn having the winding order No. 80 indicates a winding termination. The x mark in FIGS. 3 to 6 indicates a unit coil connection portion (turn coil end 11b) in which a pair of unit coils 11 are electrically connected by welding or the like. ∘ indicates the coil side 11a of the U phase, Δ indicates the coil side 11a of the V phase, and □ indicates the coil side 11a of the W phase. Each of ∘, Δ, and □ is arranged in eight layers for each slot number. The solid line indicates the coil end arranged on the upper surface (front side of the paper surface) of the stator 3. The broken line indicates the coil end arranged on the lower surface (back side of the paper surface) of the stator 3. One turn formed by two coil sides 11a having the same circled number in FIGS. 3 to 6 is defined below as one unit coil 11. An assembly of a plurality of unit coils 11 facing one magnetic pole of the rotor 2 is defined below as one pole coil 10.

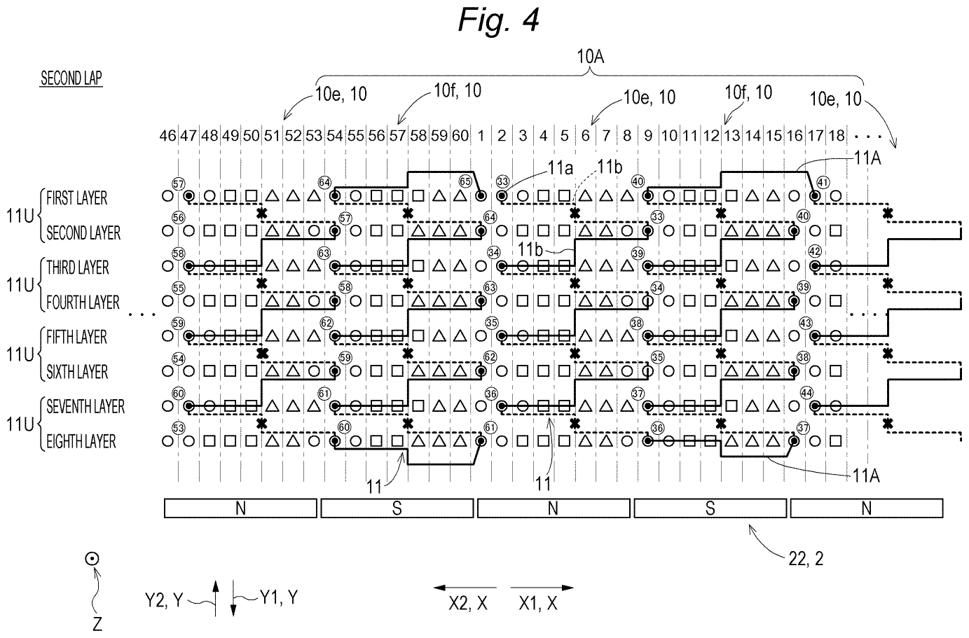

As illustrated in FIGS. 3 to 4, the coil for a laps (first lap or second lap illustrated in FIGS. 3 and 4 because a=2) is configured by an adjacent pole coil group 10A in which pole coils 10 in which the magnetic poles of the rotor 2 have the same phase as each other, and current directions are opposite to each other at the poles adjacent to each other among the magnetic poles of the rotor 2, that is, the current directions are the same as each other at the poles (one pole apart) of the magnetic poles of the rotor 2 are electrically connected to each other while being arranged to be adjacent to each other. In other words, the coil for a laps is configured by the adjacent pole coil group 10A in which, in a state where pole coils 10 of which the number is equal to the number of magnetic poles of the rotor 2 are arranged to be adjacent to each other over an entire circumference of the stator 3, the pole coils 10 adjacent to each other in the circumferential direction X are electrically and sequentially connected to each other to make one lap. Here, lap directions for the a laps are the same as each other. As illustrated in FIG. 5, the coil of the (a+1)th lap ((a+1)=3, third lap) includes the continuous-pole coil group 10B in which the continuous-pole coils 10d of which the number is the number of magnetic poles (8 poles)/c pieces (4 pieces because c=2) are arranged in the circumferential direction X. The continuous-pole coil 10d includes b pieces (b=1) of pole coils 10 that face c pieces (c=2) of magnetic poles and are electrically connected. The continuous-pole coils 10d adjacent to each other in the circumferential direction X are electrically connected by the continuous-pole coil connection portion 10C. In other words, the coil of the (a+1)th lap is configured by the continuous-pole coil group 10B in which the continuous-pole coil 10d is arranged in a range obtained by equally dividing the entire circumference of the stator 3 by the number of magnetic poles (8 poles)/c (4 equal parts because c=2), and the continuous-pole coils 10d of the number of magnetic poles/c pieces (4 pieces because c=2), which are adjacent to each other in the circumferential direction X are sequentially and electrically connected to each other and wound. In the continuous-pole coil, b pieces (b=1) of pole coils 10 and a pole coil missing portion 10g are adjacent to each other in no particular order, and the pole coils 10 that are closest to each other in the circumferential direction X are electrically connected. The pole coil missing portion is made of blanks corresponding to (c−b) pieces (c−b=1) of the pole coils 10. Here, the continuous-pole coil 10d electrically and sequentially connects the closest pole coils 10 adjacent to each other in the circumferential direction X when two or more pole coils 10 are provided. The continuous-pole coil group 10B is configured in a manner that the continuous-pole coils 10d of the number of magnetic poles/c pieces (4 pieces because c=2) are arranged at equal pitches in the circumferential direction X, and the continuous-pole coils 10d are electrically connected by the continuous-pole coil connection portion 100. As described above, the adjacent pole coil group 10A for the a laps and the continuous-pole coil group 10B for the (a+1) laps are connected in series to form a phase coil.

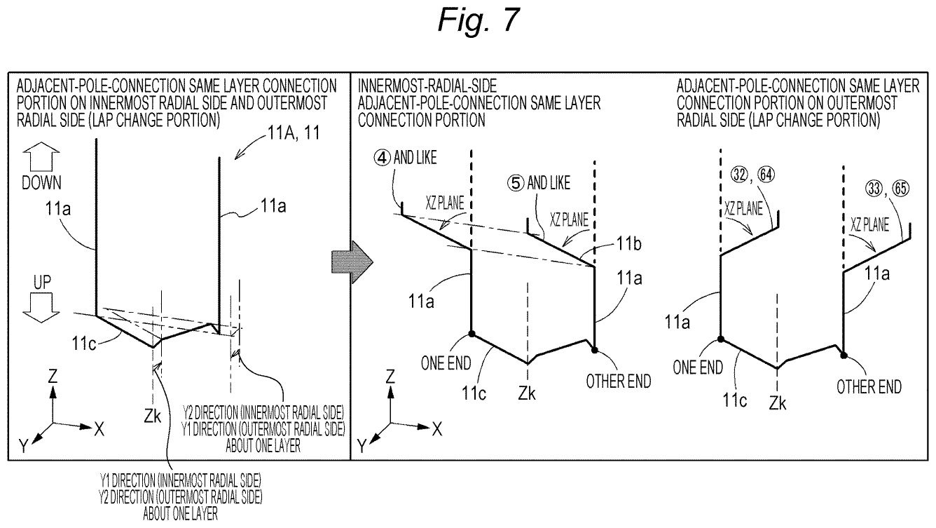

As illustrated in FIGS. 7 to 10, the unit coil 11 configured by segment conductors includes a pair of coil sides 11a accommodated in two slots 32, and one turn coil end 11b that electrically connects the pair of coil sides 11a. In this embodiment, the turn coil end 11b means a coil end required to form one turn by electrically connecting the coil sides 11a that have the same winding order (referred to as a “turn order” below, and there are 1 to 80 turns in each phase) indicated by the circled numbers in FIGS. 3 to 5. The coil end of the broken line, which includes the unit coil connection portion indicated with the x marks in FIGS. 3 to 5 are the turn coil end 11b that electrically connects the coil sides 11a having the same turn order. The coil end (coil end connecting between one turn) of the solid line, in which the coil sides 11a having the turn orders that are shifted from each other by 1 are electrically connected is not included in the turn coil end 11b for easy description. That is, as illustrated in FIGS. 7 to 10, in the unit coil 11, the coil end in which a pair of coil sides 11a are connected in advance is not included in the turn coil end 11b.

As illustrated in FIGS. 3 to 4, in the adjacent pole coil group 10A constituting the coil for a laps, a first pole coil 10e and a second pole coil 10f are alternately arranged in the circumferential direction X. The first pole coil 10e is not interposed between a pair of adjacent-pole-connection same layer connection portions 11A that electrically connect pole coils 10 that are adjacent to each other and are arranged on the outermost radial side being the most radially-outward direction Y2 of the slot 32 and on the innermost radial side being the most radially-inward direction Y1. The second pole coil 10f is interposed between a pair of adjacent-pole-connection same layer connection portions 11A. That is, in the adjacent pole coil group 10A, the first pole coils 10e configured only by the pole coils 10 that do not include the adjacent-pole-connection same layer connection portion 11A that connects the same layers in the radial direction Y of the slots 32 are arranged at each pole separated by one pole, and the second pole coils 10f including the adjacent-pole-connection same layer connection portion 11A that connects the same layers in the radial direction Y of the slots 32 are arranged at each pole separated by one pole.

As illustrated in FIG. 5, in the continuous-pole coil group 10B for a (a+1)th lap ((a+1)=3, third lap), when the number of blanks between the pole coils 10 is all odd (1), a plurality of continuous-pole coils 10d configured only by the first pole coils 10e that are not interposed between a pair of adjacent-pole-connection same layer connection portion 11A and of which the number is b (b=1) are arranged to be separated by one pole (example of a remote pole) in the circumferential direction X. The continuous-pole coil connection portion 100 electrically connects the continuous-pole coils 10d of the number of magnetic poles (8 poles)/c pieces (4 because c=2) with each other. When the number of blanks is odd (1), the continuous-pole coil connection portion 100 across the blanks electrically connects the eighth layer on the innermost radial side being the most radially-inward direction Y1 and the first layer of the slot 32 on the outermost radial side being the most radially-outward direction Y2 of the slot 32.

In summary, the phase coil configuration in this embodiment is obtained in a manner as follows. A configuration in which the pole coils 10 adjacent to each other in the circumferential direction X are electrically connected by the adjacent-pole-connection same layer connection portion 11A is rotated a times in the rotation direction X1. Then, one lap is made in the rotation direction X1 with the continuous-pole coil group 10B in which the b pieces of pole coils 10 and the pole coil missing portion 10g made of blanks corresponding to (c−b) pieces (c−b=1) of the pole coils 10 are adjacent to each other in no particular order, for each of c continuous-poles, and the continuous-pole coils 10d of the number of magnetic poles/c arranged in the circumferential direction X that electrically connect the pole coils 10 that are closest to each other in the circumferential direction X are sequentially and electrically connected by the continuous-pole coil connection portion 100. With this configuration, the adjacent pole coil group 10A or the continuous-pole coil group 10B for the second lap and subsequent laps is shifted from the adjacent pole coil group 10A for the previous lap, in a direction (reverse rotation direction X2) opposite to an a-lap direction (rotation direction X1) by one slot pitch. For example, as illustrated in FIGS. 3 to 4, the 36th turn (coil-side-arrangement slots 2 and 9) is shifted from the fourth turn (same arrangement slots 3 and 10) by one slot pitch in a direction opposite to the a lap direction. As illustrated in FIGS. 4 to 5, the 68th turn (same arrangement slots 1 and 8) is shifted from the 36th turn by one slot pitch in the direction opposite to the a-lap direction.

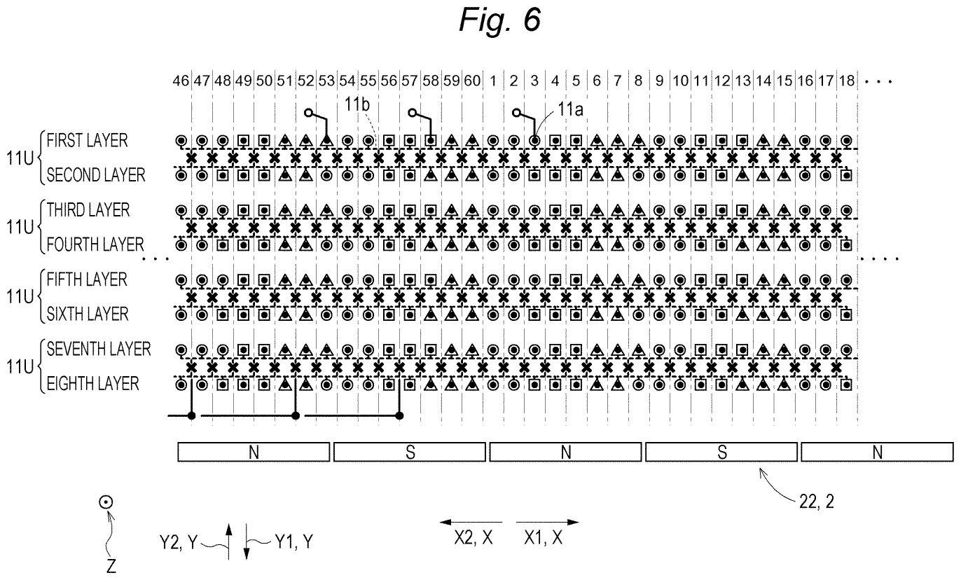

FIG. 6 illustrates a schematic plan view (illustrating the coil end arranged on the lower end surface (back side of the paper surface) of the stator core 31) without illustrations of the adjacent-pole-connection same layer connection portion 11A and the continuous-pole coil connection portion 100 arranged on the upper end surface (front side of the paper surface) of the stator core 31 when the coil of three phases being the U phase, the V phase, and the W phase is wound around the slot 32 based on the above regulations. As can be seen from FIG. 6, it is possible to visually recognize that the unit coil connection portion (turn coil end 11b) in which the pair of unit coils 11 are electrically connected by welding or the like can be arranged evenly without being interfered by another coil and another connection portion between coil turns (coil side connection portion 11c). Thus, after all the coil sides 11a of the unit coils 11 configured by segment conductors of the three phases being the U phase, the V phase, and the W phase are inserted into the slot 32, the coil turn connection portion (turn coil end 11b) is bent. Thus, the work of connecting the pair of unit coils 11 by welding or the like becomes very easy. When a≥2, in each phase, a connecting portion to the next lap is reduced by one slot pitch by another equivalent connection portion between adjacent pole coils. This is because the pole coils 10 for the second and subsequent laps are shifted from the previous pole coil by one slot pitch in the circumferential direction X being a direction opposite to the a-lap direction. Thus, at this location, the bending position and the like that cause the connection portion between coil turns or a neutral-point extraction portion to have an arrangement relation equivalent to others are adjusted.

FIGS. 7 to 10 illustrate the unit coil 11 for the adjacent-pole-connection same layer connection portion 11A on the innermost radial side and the outermost radial side (lap change portion), the unit coil 11 of the pole coil 10 not for the adjacent-pole-connection same layer connection portion 11A, the unit coil 11 for the adjacent-pole-connection same layer connection portion 11A on the outermost radial side (except for the lap change portion), and the unit coil 11 for the continuous-pole coil connection portion 100. As illustrated in FIGS. 3 to 5, the total of 80 unit coils 11 that are 10 unit coils 11 for the adjacent-pole-connection same layer connection portions 11A (lap change portions) on the innermost radial side and the outermost radial side, 60 unit coils 11 of the pole coils 10 not for the adjacent-pole-connection same layer connection portion 11A, 6 unit coils 11 for the adjacent-pole-connection same layer connection portions 11A on the outermost radial side (except for the lap change portion), 3 unit coils 11 for the continuous-pole coil connection portions 10C, and one unit coil 11 substantially considered as one piece by a combination of the winding start end and each half turn of the winding termination are used for the U phase of a motor M of 8 poles and 60 slots. The winding configuration using the unit coil 11 will be described below with reference to FIGS. 3 to 10. The slot numbers illustrated in the upper part of FIGS. 3 to 6 are referred to as a first slot to a 60th slot. Description will be made on the assumption that the side of the turn coil end 11b illustrated in FIGS. 7 to 10 is set to be the bottom (back side of the paper surface in the Z direction illustrated in FIG. 3), and the opposite side (front side of the paper surface in the Z direction illustrated in FIG. 3) is set to be the top. In FIGS. 3 to 6, the solid line indicates the coil end arranged on the upper surface of the stator 3, and the broken line indicates the coil end arranged on the lower surface of the stator 3.

As illustrated in the left view of FIG. 7, in the unit coil 11 for the adjacent-pole-connection same layer connection portion 11A on the innermost radial side and the adjacent-pole-connection same layer connection portion 11A on the outermost radial side (two lap change portions), a pair of linear coil sides 11a are connected to both ends of the coil side connection portion 11c configured with the short-section pitch. The coil side connection portion 11c on the innermost radial side is bent in in the radially-inward direction Y1 at the central portion (reference position Zk) extending from one end by a slot pitch of the short-section pitch/2, and is bent in the radially-outward direction Y2 at the other end extending from the central portion. The coil side connection portion 11c on the outermost radial side (lap change portion) is bent in in the radially-outward direction Y2 at the central portion (reference position Zk) extending from one end by a slot pitch of the short-section pitch/2, and is bent in the radially-inward direction Y1 at the other end extending from the central portion.

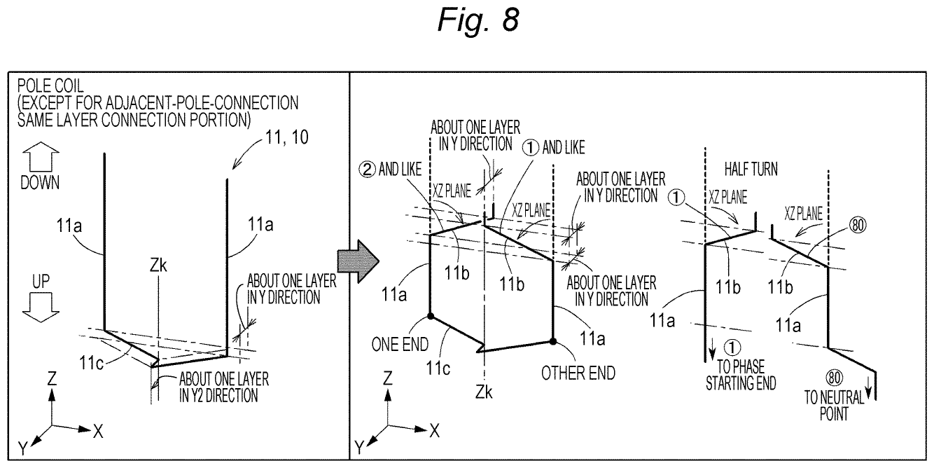

As illustrated in the left view of FIG. 8, in the unit coil 11 of the pole coil 10 not for the adjacent-pole-connection same layer connection portion 11A, a pair of linear coil sides 11a are connected to both ends of the coil side connection portion 11c configured with the short-section pitch. The coil side connection portion 11c is bent in in the radially-outward direction Y2 at the central portion (reference position Zk) extending from one end by a slot pitch of the short-section pitch/2.

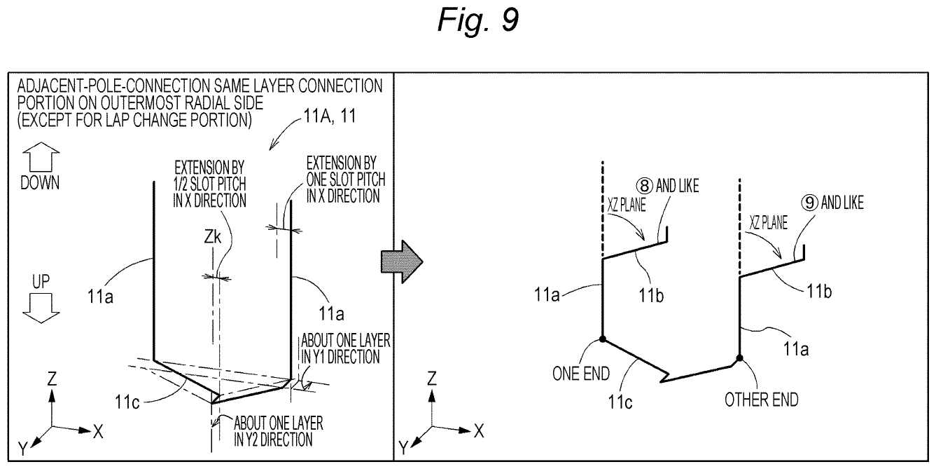

As illustrated in the left view of FIG. 9, in the unit coil 11 for the adjacent-pole-connection same layer connection portion 11A on the outermost radial side (six pieces except for the lap change portions), a pair of linear coil sides 11a are connected to both ends of the coil side connection portion 11c configured with the long-section pitch. The coil side connection portion 11c is bent in in the radially-outward direction Y2 at the central portion extending from one end by a slot pitch of the long-section pitch/2, and is bent in the radially-inward direction Y1 at the other end extending from the central portion. That is, the coil side connection portion 11c configured with the long-section pitch extends the central portion (reference position Zk) of the above-described coil side connection portion 11c configured with the short-section pitch, in the circumferential direction X by ½ slot pitch, and extends the other end of the coil side connection portion 11c in the circumferential direction X by one slot pitch.

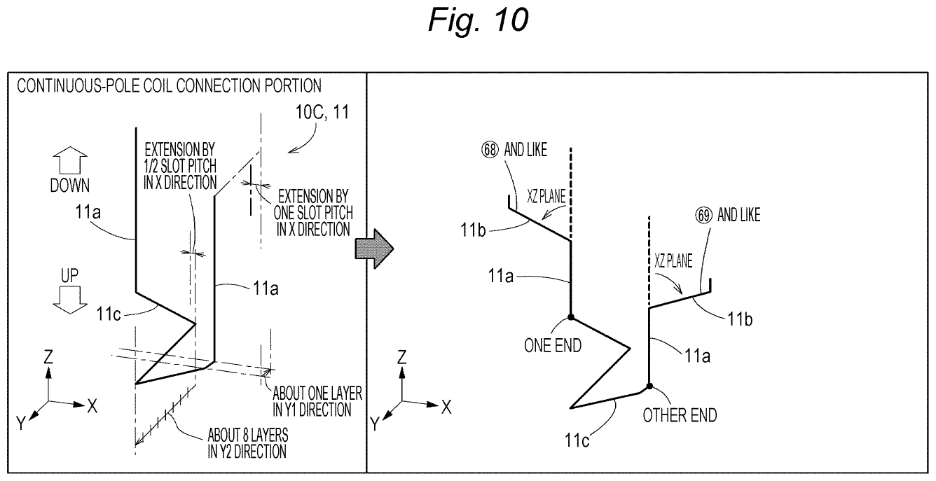

As illustrated in the left view of FIG. 10, in the unit coil 11 for the continuous-pole coil connection portion 100, a pair of linear coil sides 11a are connected to both ends of the coil side connection portion 11c configured with the long-section pitch. The coil side connection portion 11c is bent in in the radially-outward direction Y2 at the central portion extending from one end by a slot pitch of the long-section pitch/2, and is bent in the radially-inward direction Y1 at the other end extending from the central portion. That is, the coil side connection portion 11c configured with the long-section pitch extends the central portion (reference position Zk) of the above-described coil side connection portion 11c configured with the short-section pitch, in the circumferential direction X by ½ slot pitch, and extends the other end of the coil side connection portion 11c in the circumferential direction X by one slot pitch.

Then, the turn order using the unit coil 11 described above will be described. As illustrated in FIGS. 3 and 8, in a first turn to a second turn as the start turn of a first lap, in the unit coil 11 of the pole coil 10, the coil side 11a is inserted into the third layer of the third slot and the second layer of the 10th slot so that the coil side connection portion 11c being one coil end is arranged above the stator 3. As illustrated in the central view of FIG. 8, the other coil end is formed in a manner that a linear winding including the coil side 11a connected to one end of the coil side connection portion 11c is bent inward of the turn, and a linear winding including the coil side 11a connected to the other end of the coil side connection portion 11c is bent inward of the turn. As illustrated in the right view of FIG. 8, the turn coil end 11b for the first turn may be formed by bending one linear end of the coil side 11a for the half turn inward of the turn and then is connected with a coil end located on the other end side of the coil side connection portion 11c for the first turn to the second turn by welding or the like. The tip of the other linear end of the coil side 11a for the half turn may be electrically connected to the phase starting end or may constitute the phase starting end. In this embodiment, the phase starting end of the coil is pulled out from the slot 32 (third slot) at the end of a phase band on the a-lap direction side. In the phase band, the number of continuous slots being the number of slots 32 in which coil sides 11a that are continuous in the circumferential direction X and have the same phase are arranged at the bottom (first layer) of the slot 32 is the larger integer (3) of the integers (2 and 3) closest to Nspp (2.5). The phase band including the slot 32 for pulling out the phase starting end is a phase band (for example, first, second, and third slots in which the number of continuous slots is 3) in which the number of odd-numbered (first) continuous slots at the shortest distance in the circumferential direction X is relatively large with respect to a phase band (for example, 54th and 55th slots in which the number of continuous slots is 2) in which the number of continuous slots constituting a layer-phase band at the bottom (first layer) of the slot 32 is relatively small.

As illustrated in FIGS. 3 and 8, in the second turn to a third turn, in the unit coil 11 of the pole coil 10, the coil side 11a is inserted into the fifth layer of the third slot and the fourth layer of the 10th slot so that the coil side connection portion 11c being one coil end is arranged above the stator 3. As illustrated in the central view of FIG. 8, the other coil end is formed in a manner that a linear winding including the coil side 11a connected to one end of the coil side connection portion 11c is bent inward of the turn, and a linear winding including the coil side 11a connected to the other end of the coil side connection portion 11c is bent inward of the turn. The coil end located on the other end side of the coil side connection portion 11c for the second turn to the third turn is connected with the coil end located on the one end side of the coil side connection portion 11c for the first turn to the second turn by welding or the like. In this manner, the turn coil end 11b for the second turn is formed.

As illustrated in FIGS. 3 and 8, in the third turn to a fourth turn, in the unit coil 11 of the pole coil 10, the coil side 11a is inserted into the seventh layer of the third slot and the sixth layer of the 10th slot so that the coil side connection portion 11c being one coil end is arranged above the stator 3. As illustrated in the central view of FIG. 8, the other coil end is formed in a manner that a linear winding including the coil side 11a connected to one end of the coil side connection portion 11c is bent inward of the turn, and a linear winding including the coil side 11a connected to the other end of the coil side connection portion 11c is bent inward of the turn. The coil end located on the other end side of the coil side connection portion 11c for the third turn to the fourth turn is connected with the coil end located on the one end side of the coil side connection portion 11c for the second turn to the third turn by welding or the like. In this manner, the turn coil end 11b for the third turn is formed.

As illustrated in FIGS. 3 and 7, in the fourth turn to a fifth turn, in the unit coil 11 for the adjacent-pole-connection same layer connection portion 11A on the innermost radial side, the coil side 11a is inserted into the eighth layer of the 10th slot and the eighth layer of the 17th slot so that the coil side connection portion 11c (adjacent-pole-connection same layer connection portion 11A) being one coil end is arranged above the stator 3. As illustrated in the central view of FIG. 7, the other coil end is formed in a manner that a linear winding including the coil side 11a connected to one end of the coil side connection portion 11c is bent outward of the turn, and a linear winding including the coil side 11a connected to the other end of the coil side connection portion 11c is bent inward of the turn. The coil end located on the one end side of the coil side connection portion 11c (adjacent-pole-connection same layer connection portion 11A) for the fourth turn to the fifth turn is connected with the coil end located on the one end side of the coil side connection portion 11c for the third turn to the fourth turn by welding or the like. In this manner, the turn coil end 11b for the fourth turn is formed. In this manner, the first pole coil 10e configured in the turn order from the first turn to the fourth turn is formed.

The coil end located on the other end side of the coil side connection portion 11c for the fourth turn to the fifth turn is connected with the coil end located on the one end side of the coil side connection portion 11c for the fifth turn to a sixth turn by welding or the like. In this manner, the turn coil end 11b for the fifth turn is formed. Since turns of the fifth turn to an eighth turn are made by repetition in a similar manner to that for the turns of the first turn to the fourth turn, description thereof will not be repeated.

As illustrated in FIGS. 3 and 9, in the eighth turn to a ninth turn, in the unit coil 11 for the adjacent-pole-connection same layer connection portion 11A on the outermost radial side (except for the lap change portion), the coil side 11a is inserted into the first layer of the 10th slot and the first layer of the 18th slot so that the coil side connection portion 11c being one coil end is arranged above the stator 3. As illustrated in the right view of FIG. 9, the other coil end is formed in a manner that a linear winding including the coil side 11a connected to one end of the coil side connection portion 11c is bent inward of the turn, and a linear winding including the coil side 11a connected to the other end of the coil side connection portion 11c is bent outward of the turn. The coil end located on the one end side of the coil side connection portion 11c for the eighth turn to the ninth turn is connected with the coil end located on the other end side of the coil side connection portion 11c for the seventh turn to the eighth turn by welding or the like. In this manner, the turn coil end 11b for the eighth turn is formed. The coil end located on the other end side of the coil side connection portion 11c for the eighth turn to the ninth turn is connected with the coil end located on the other end side of the coil side connection portion 11c for the ninth turn to a 10th turn by welding or the like. In this manner, the turn coil end 11b for the ninth turn is formed. Similarly, since turns of the ninth turn to a 16th turn are made by repetition in a similar manner to that for the turns of the first turn to the eighth turn, description thereof will not be repeated.

The first lap is completed by repeating the repetition from the ninth turn to the 16th turn, from a 17th turn to a 24th turn and from a 25th turn to a 32nd turn. As will be described later, the adjacent-pole-connection same layer connection portion 11A on the outermost radial side (lap change portion) of the 32nd turn to a 33rd turn has a short-section pitch.

As illustrated in FIGS. 3, 4, and 7, in the 32nd turn to the 33rd turn as the start end of a second lap, in the unit coil 11 for the adjacent-pole-connection same layer connection portion 11A (lap change portion) on the outermost radial side, the coil side 11a is inserted into the first layer of the 55th slot and the first layer of the second slot so that the coil side connection portion 11c (adjacent-pole-connection same layer connection portion 11A) being one coil end is arranged above the stator 3. As illustrated in the right view of FIG. 7, the other coil end is formed in a manner that a linear winding including the coil side 11a connected to one end of the coil side connection portion 11c is bent inward of the turn, and a linear winding including the coil side 11a connected to the other end of the coil side connection portion 11c is bent outward of the turn. At this time, since, in the 32nd turn to the 33rd turn, the unit coil 11 that connects the first lap and the second lap which is shifted from the first lap by one slot pitch in the direction opposite to the a-lap direction is obtained, the adjacent-pole-connection same layer connection portion 11A (lap change portion) is reduced by one slot pitch in the circumferential direction X with respect to the adjacent-pole-connection same layer connection portion 11A (except for the lap change portion). The coil end located on the one end side of the coil side connection portion 11c for the 32nd turn to the 33rd turn is connected with the coil end located on the other end side of the coil side connection portion 11c for the 31st turn to the 32nd turn by welding or the like. In this manner, the turn coil end 11b for the 32nd turn is formed. The coil end located on the other end side of the coil side connection portion 11c for the 32nd turn to the 33rd turn is connected with the coil end located on the other end side of the coil side connection portion 11c for the 33rd turn to a 34th turn by welding or the like. In this manner, the turn coil end 11b for the 33rd turn is formed.

The second lap is completed by repeating turns of the 33rd turn to a 64th turn in a similar manner to that for the turns of the first turn to the 32nd turn.

As illustrated in FIGS. 4, 5, and 7, in the 64th turn to a 65th turn as the start end of a third lap, in the unit coil 11 for the adjacent-pole-connection same layer connection portion 11A (lap change portion) on the outermost radial side, the coil side 11a is inserted into the first layer of the 54th slot and the first layer of the first slot so that the coil side connection portion 11c being one coil end is arranged above the stator 3. As illustrated in the right view of FIG. 7, the other coil end is formed in a manner that a linear winding including the coil side 11a connected to one end of the coil side connection portion 11c is bent inward of the turn, and a linear winding including the coil side 11a connected to the other end of the coil side connection portion 11c is bent outward of the turn. At this time, since, in the 64th turn to the 65th turn, the unit coil 11 that connects the second lap and the third lap which is shifted from the second lap by one slot pitch in the direction opposite to the a-lap direction is obtained, the adjacent-pole-connection same layer connection portion 11A (lap change portion) has a short-section pitch. The coil end located on the one end side of the coil side connection portion 11c for the 64th turn to the 65th turn is connected with the coil end located on the other end side of the coil side connection portion 11c for the 63rd turn to the 64th turn by welding or the like. In this manner, the turn coil end 11b for the 64th turn is formed. The coil end located on the other end side of the coil side connection portion 11c for the 64th turn to the 65th turn is connected with the coil end located on the other end side of the coil side connection portion 11c for the 65th turn to a 66th turn by welding or the like. In this manner, the turn coil end 11b for the 65th turn is formed.

Since turns of the 65th turn to a 68th turn are made by repetition in a similar manner to that for the above-described turns of the first turn to the fourth turn, description thereof will not be repeated.

As illustrated in FIGS. 5 and 10, in the 68th turn to a 69th turn, in the unit coil 11 for the continuous-pole coil connection portion 100, the coil side 11a is inserted into the eighth layer of the eighth slot and the first layer of the 16th slot so that the coil side connection portion 11c being one coil end is arranged above the stator 3. As illustrated in the right view of FIG. 10, the other coil end is formed in a manner that a linear winding including the coil side 11a connected to one end of the coil side connection portion 11c is bent outward of the turn, and a linear winding including the coil side 11a connected to the other end of the coil side connection portion 11c is bent outward of the turn. The coil end located on one end side of the coil side connection portion 11c for the 68th turn to a 69th turn is connected with the coil end located on the one end side of the coil side connection portion 11c for the 67th turn to the 68th turn by welding or the like. In this manner, the turn coil end 11b for the 68th turn is formed. The coil end located on the other end side of the coil side connection portion 11c for the 68th turn to the 69th turn is connected with the coil end located on the other end side of the coil side connection portion 11c for the 69th turn to a 70th turn by welding or the like. In this manner, the turn coil end 11b for the 69th turn is formed.

Similarly, since turns of the 69th turn to a 72nd turn and turns of a 73rd turn to a 76th turn are made by repetition in a similar manner to that for the turns of the 65th turn to the 68th turn, description thereof will not be repeated.

Since turns of a 77th turn to a 80th turn are similar to the 65th turn to the 68th turn except that there is no continuous-pole coil connection portion 10C, description thereof will not be repeated. Finally, as illustrated in the right view of FIGS. 5 and 8, the turn coil end 11b for the 80th turn is formed by bending one linear end of the coil side 11a for the half turn inward of the turn and then is connected with a coil end located on one end side of the coil side connection portion 11c for the 79th turn to the 80th turn by welding or the like. The tip of the other linear end of the coil side 11a for the half turn is electrically connected to the neutral point as the phase termination.

In a manufacturing method of the winding configuration of the motor M, the unit coil 11 for the adjacent-pole-connection same layer connection portion 11A on the innermost radial side and the outermost radial side (lap change portion) illustrated in FIG. 7, the unit coil 11 of the pole coil 10 illustrated in FIG. 8, the unit coil 11 for the adjacent-pole-connection same layer connection portion 11A on the outermost radial side (except for the lap change portion) illustrated in FIG. 9, and the unit coil 11 for the continuous-pole coil connection portion 100 illustrated in FIG. 10 are arranged above the stator 3, as a coil group arranged in the above-described turn order, and the coil sides 11a of the unit coils 11 are collectively inserted into the slots 32. Then, the turn coil end 11b in which the coil ends of a pair of unit coils 11 are electrically connected by welding or the like is produced by bending a linear winding including the coil side 11a of the unit coil 11 inserted into the slot 32 except for the other linear end of the coil side 11a for the half turn of the first turn and the 80th turn. A linear winding including the coil side 11a connected to the other end of the coil side connection portion 11c in the first turn of the U phase, the V phase, and the W phase is electrically connected to the phase starting end of each phase, or the phase starting end is directly formed on the linear winding. Then, linear windings including the coil side 11a connected to the other end of the coil side connection portion 11c in the 80th turn of the U phase, the V phase, and the W phase are electrically connected to each other to form the neutral point. As a result, the motor M in which the three-phase coils are electrically connected by Y connection is completed.

As described above, the unit coil 11 for 10 adjacent-pole-connection same layer connection portions 11A on the innermost radial side and the outermost radial side (lap change portion) illustrated in FIG. 7, and the unit coil 11 of 60 pole coils 10 illustrated in FIG. 8 are configured with the short-section pitch in which the turn coil end 11b is inclined or bent by one layer from the outer radial side to the inner radial side (Y1 direction) in the a-lap direction, and the coil side connection portion 11c is also configured with the short-section pitch. In addition, the unit coil 11 for the six adjacent-pole-connection same layer connection portions 11A on the outermost radial side (except for the lap change portion) illustrated in FIG. 9, the unit coil 11 for the three continuous-pole coil connection portions 100 illustrated in FIG. 10, and the unit coil 11 substantially considered as one piece by a combination of the winding start end illustrated in FIG. 8 and each half turn of the winding termination are configured with the short-section pitch in which the turn coil end 11b is inclined or bent by one layer from the outer radial side to the inner radial side (Y1 direction) in the a-lap direction, and the coil side connection portion 11c other than the winding start end illustrated in FIG. 8 and each half turn of the winding termination is configured with the long-section pitch. As described above, 80 unit coils 11 have short-section pitch turn coil ends 11b, 70 unit coils 11 have short-section pitch coil side connection portions 11c, and nine unit coils 11 have long-section pitch coil side connection portions 11c. Thus, two unit coils 11 for half a turn are required, but most of unit coils 11 are configured with the short-section pitch. Thus, the total coil length of the motor M is shorter than that of the wave winding. As described above, in the motor M in this embodiment, it is possible to reduce the total coil length and reduce the manufacturing cost.

Although not illustrated in FIG. 6, the coil end for the adjacent-pole-connection same layer connection portion 11A illustrated in FIGS. 7 and 9 is bent in the Y direction by about one layer so as to be arranged on the outermost radial side or the innermost radial side. Therefore, there is no interference with the turn coil end 11b of the unit coil 11. Since the coil end except for the upper surface crossing portion of the stator 3 in the Y direction among the coil ends of the continuous-pole coil connection portion 100 illustrated in FIG. 10 is bent in the Y direction by about one layer so as to be arranged on the outermost radial side or the innermost radial side, there is no interference with the turn coil end 11b of the unit coil 11. The adjacent-pole-connection same layer connection portions 11A of the U-phase, the V-phase, and the W-phase do not interfere with the continuous-pole coil connection portions 100 of the U-phase, the V-phase, and the W-phase because the slot numbers are shifted in the circumferential direction X. The upper surface Y-direction crossing portion of the stator 3 is further crossed above the coil side connection portion 11c of the unit coil 11 to avoid the interference. As a result, the coil ends are evenly arranged on the upper and lower surfaces in the Y direction, the inner circumferential surface, and the outer circumferential surface of the stator 3, and thus it is possible to make the outer shape of the motor M compact. In addition, in this embodiment, since the winding start end can be arranged on the outermost radial side and the neutral point can be arranged on the innermost radial side, it is possible to more reduce the dimension in the radial direction Y.

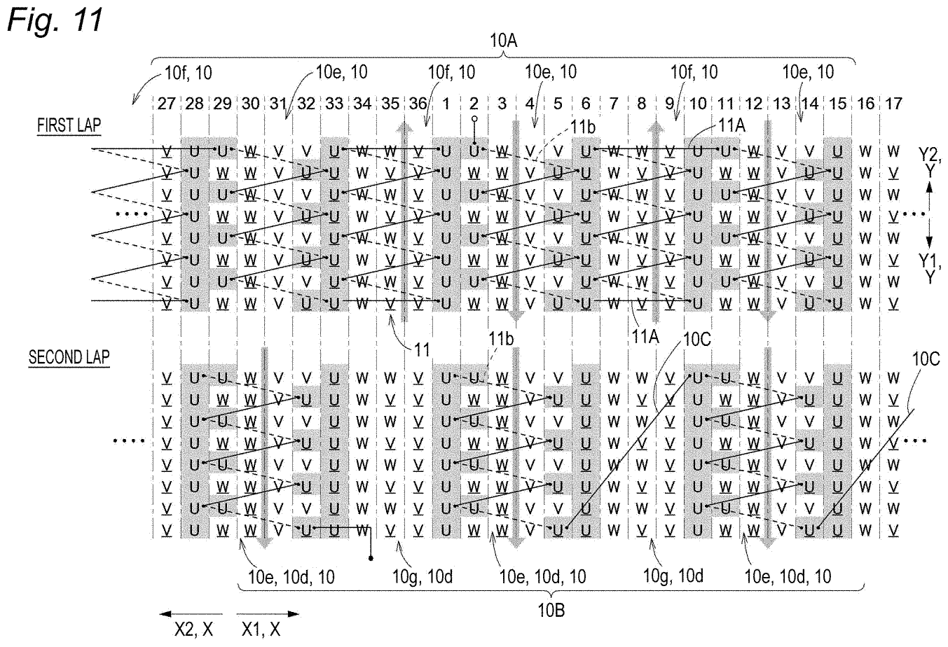

An example of the winding configuration of the fractional slots in which the number of slots per pole and phase is more than ½, and the denominator is equal to or more than 2 when the number of slots per pole and phase is expressed by an irreducible fraction will be described below, as a motor M other than the motor M of 8 poles and 60 slots, with reference to FIGS. 11 to 16. The numbers in the upper part of FIGS. 11 to 16 indicate the slot numbers. The white circles pulled in the Y2 direction in FIGS. 11 to 16 indicate the winding start end. The black circles pulled in the Y1 direction in FIGS. 11 to 16 indicate the winding termination. The solid line connecting the coil sides 11a accommodated in two slots 32 in FIGS. 11 to 16 schematically indicates the coil end arranged on the upper surface of the stator 3. The broken line connecting the coil sides 11a accommodated in two slots 32 schematically indicates the coil end arranged on the lower surface of the stator 3.

FIG. 11 illustrates the winding configuration of a motor M of 8 poles and 36 slots (Nspp=1.5, a=1, b=1, and c=2). Since the motor M of 8 poles and 36 slots has the number of slots per pole, which is 4.5, the short-section pitch is provided for four slots (short-section winding) or the long-section pitch is provided for five slots (long-section winding). In this embodiment, the unit coil 11 of the pole coil 10 is configured with the short-section pitch in which the turn coil end 11b (broken-line portion) is inclined or bent by one layer from the outer radial side to the inner radial side (Y1 direction) in the a-lap direction. As described above, the even-numbered layer of the slot 32 is configured by moving the odd-numbered layer of the slot 32 in the circumferential direction X by a predetermined slot number (here, 4 or 5) configured by an integer closest to the number of slots per pole. Here, when c=2, the movement direction of the even-numbered layer by the predetermined slot number with respect to the odd-numbered layer is either the rotation direction X1 or the reverse rotation direction X2. The layer-phase band arrangement of even-numbered layers or the layer-phase band arrangement of the odd-numbered layers have the same configuration in the circumferential direction X.

As illustrated in FIG. 11, the coil for the a laps (a=1) is configured by an adjacent pole coil group 10A in which pole coils 10 in which the magnetic poles of the rotor 2 have the same phase as each other, and current directions are opposite to each other at the poles adjacent to each other among the magnetic poles of the rotor 2, that is, the current directions are the same as each other at the poles (one pole apart) of the magnetic poles of the rotor 2 are electrically connected to each other while being arranged to be adjacent to each other. In other words, the coil for a laps is configured by the adjacent pole coil group 10A in which, in a state where pole coils 10 of which the number is equal to the number of magnetic poles of the rotor 2 are arranged to be adjacent to each other over an entire circumference of the stator 3, the pole coils 10 adjacent to each other in the circumferential direction X are electrically and sequentially connected to each other to make one lap. The coil of the (a+1)th lap ((a+1)=2, second lap) includes the continuous-pole coil group 10B in which the continuous-pole coils 10d of which the number is the number of magnetic poles (8 poles)/c pieces (4 pieces because c=2) are arranged in the circumferential direction X. The continuous-pole coil 10d includes b pieces (b=1) of pole coils 10 that face c pieces (c=2) of magnetic poles and are electrically connected. The continuous-pole coils 10d adjacent to each other in the circumferential direction X are electrically connected by the continuous-pole coil connection portion 10C. In other words, the coil of the (a+1)th lap is configured by the continuous-pole coil group 10B in which the continuous-pole coil 10d is arranged in a range obtained by equally dividing the entire circumference of the stator 3 by the number of magnetic poles (8 poles)/c (4 equal parts because c=2), and the continuous-pole coils 10d of the number of magnetic poles/c pieces (4 pieces because c=2), which are adjacent to each other in the circumferential direction X are sequentially and electrically connected to each other and wound. In the continuous-pole coil, b pieces (b=1) of pole coils 10 and a pole coil missing portion 10g are adjacent to each other in no particular order, and the pole coils 10 that are closest to each other in the circumferential direction X are electrically connected. The pole coil missing portion is made of blanks corresponding to (c−b) pieces (c−b=1) of the pole coils 10.

In the adjacent pole coil group 10A constituting the coil for the a (a=1) laps, the first pole coil 10e and the second pole coil 10f are alternately arranged in the circumferential direction X. The first pole coil 10e is not interposed between a pair of adjacent-pole-connection same layer connection portions 11A that electrically connect pole coils 10 that are adjacent to each other and are arranged on the outermost radial side and the innermost radial side of the slot 32. The second pole coil 10f is interposed between a pair of adjacent-pole-connection same layer connection portions 11A. The adjacent-pole-connection same layer connection portion 11A that connects the same layers in the radial direction Y of the slots 32 is arranged on the outermost radial side and the innermost radial side of the slot 32. The phase starting end of the coil is pulled out from the slot 32 (second slot) at the end of a phase band on the a-lap direction side. In the phase band, the number of continuous slots being the number of slots 32 in which coil sides 11a that are continuous in the circumferential direction X and have the same phase are arranged at the bottom (first layer) of the slot 32 is the larger integer (2) of the integers (1 and 2) closest to Nspp (1.5). The phase band including the slot 32 for pulling out the phase starting end is a phase band (for example, first and second slots in which the number of continuous slots is 2) in which the number of odd-numbered (first) continuous slots at the shortest distance in the circumferential direction X is relatively large with respect to a phase band (for example, sixth slot in which the number of continuous slots is 1) in which the number of continuous slots constituting a layer-phase band at the bottom (first layer) of the slot 32 is relatively small.

The continuous-pole coil group 10B for the (a+1)th lap ((a+1)=2, second lap) is configured only by b pieces (b=1) of the first pole coils 10e that are not interposed between the pair of adjacent-pole-connection same layer connection portions 11A when the number of blanks between the pole coils 10 is all odd (1). When the number of blanks is odd (1) in the continuous-pole coils 10d of the number of magnetic poles (8 poles)/c pieces (4 pieces because c=2), the continuous-pole coil connection portion 100 across the blanks electrically connects the layer of the slot 32 on the outermost radial side and the layer on the innermost radial side. The continuous-pole coil group 10B for the second lap and subsequent laps is shifted from the adjacent pole coil group 10A for the previous (first) lap in the direction opposite to the a-lap direction by one slot pitch.

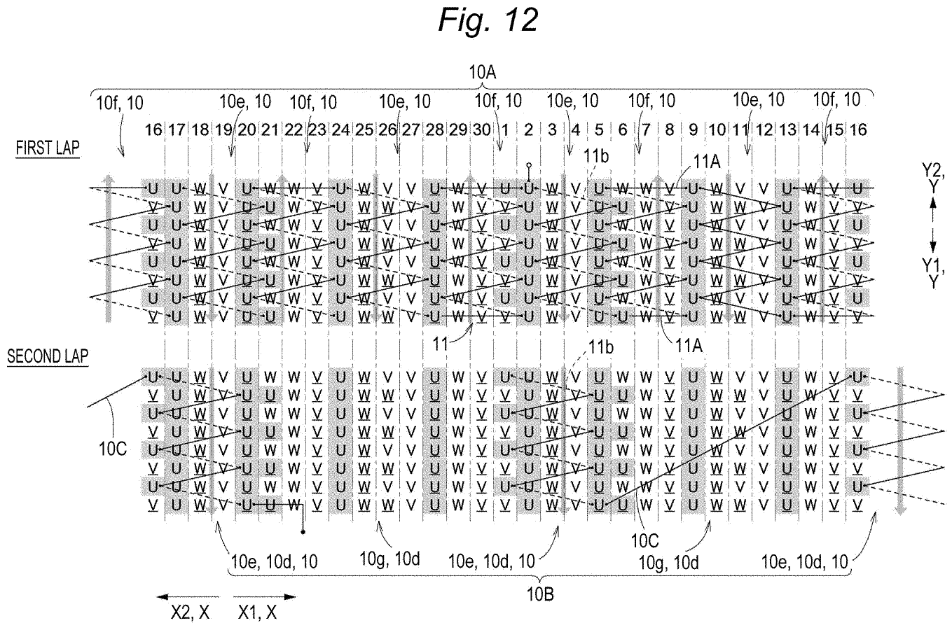

FIG. 12 illustrates the winding configuration of a motor M of 8 poles and 30 slots (Nspp=1.25, a=1, b=1, and c=4). Since the motor M of 8 poles and 30 slots has the number of slots per pole, which is 3.75, the short-section pitch is provided for three slots (short-section winding) or the long-section pitch is provided for four slots (long-section winding). In this embodiment, the unit coil 11 of the pole coil 10 is configured with the long-section pitch in which the turn coil end 11b (broken-line portion) is inclined or bent by one layer from the outer radial side to the inner radial side (Y1 direction) in the a-lap direction. As described above, the even-numbered layer of the slot 32 is configured by moving the odd-numbered layer of the slot 32 in the circumferential direction X by a predetermined slot number (here, 3 or 4) configured by an integer closest to the number of slots per pole. Here, when c is equal to or more than 4 (c=4), the movement direction of the even-numbered layer by the predetermined slot number with respect to the odd-numbered layer is the same direction (rotation direction X1) as the a-lap direction (rotation direction X1). The layer-phase band arrangement of even-numbered layers or the layer-phase band arrangement of the odd-numbered layers have the same configuration in the circumferential direction X.

As illustrated in FIG. 11, the coil for the a laps (a=1) is configured by an adjacent pole coil group 10A in which pole coils 10 in which the magnetic poles of the rotor 2 have the same phase as each other, and current directions are opposite to each other at the poles adjacent to each other among the magnetic poles of the rotor 2, that is, the current directions are the same as each other at the poles (one pole apart) of the magnetic poles of the rotor 2 are electrically connected to each other while being arranged to be adjacent to each other. In other words, the coil for a laps is configured by the adjacent pole coil group 10A in which, in a state where pole coils 10 of which the number is equal to the number of magnetic poles of the rotor 2 are arranged to be adjacent to each other over an entire circumference of the stator 3, the pole coils 10 adjacent to each other in the circumferential direction X are electrically and sequentially connected to each other to make one lap. The coil of the (a+1)th lap ((a+1)=2, second lap) includes the continuous-pole coil group 10B in which the continuous-pole coils 10d of which the number is the number of magnetic poles (8 poles)/c pieces (2 pieces because c=4) are arranged in the circumferential direction X. The continuous-pole coil 10d includes b pieces (b=1) of pole coils 10 that face c pieces (c=4) of magnetic poles and are electrically connected. The continuous-pole coils 10d adjacent to each other in the circumferential direction X are electrically connected by the continuous-pole coil connection portion 100. In other words, the coil of the (a+1)th lap is configured by the continuous-pole coil group 10B in which the continuous-pole coil 10d is arranged in a range obtained by equally dividing the entire circumference of the stator 3 by the number of magnetic poles (8 poles)/c (4 equal parts because c=2), and the continuous-pole coils 10d of the number of magnetic poles/c pieces (4 pieces because c=2), which are adjacent to each other in the circumferential direction X are sequentially and electrically connected to each other and wound. In the continuous-pole coil, b pieces (b=1) of pole coils 10 and a pole coil missing portion 10g are adjacent to each other in no particular order, and the pole coils 10 that are closest to each other in the circumferential direction X are electrically connected. The pole coil missing portion is made of blanks corresponding to (c−b) pieces (c−b=3) of the pole coils 10.

In the adjacent pole coil group 10A constituting the coil for the a (a=1) laps, the first pole coil 10e and the second pole coil 10f are alternately arranged in the circumferential direction X. The first pole coil 10e is not interposed between a pair of adjacent-pole-connection same layer connection portions 11A that electrically connect pole coils 10 that are adjacent to each other and are arranged on the outermost radial side and the innermost radial side of the slot 32. The second pole coil 10f is interposed between a pair of adjacent-pole-connection same layer connection portions 11A. The adjacent-pole-connection same layer connection portion 11A that connects the same layers in the radial direction Y of the slots 32 is arranged on the outermost radial side and the innermost radial side of the slot 32. The phase starting end of the coil is pulled out from the slot 32 (second slot) at the end of a phase band on the a-lap direction side. In the phase band, the number of continuous slots being the number of slots 32 in which coil sides 11a that are continuous in the circumferential direction X and have the same phase are arranged at the bottom (first layer) of the slot 32 is the larger integer (2) of the integers (1 and 2) closest to Nspp (1.25). The phase band including the slot 32 for pulling out the phase starting end is a phase band (for example, first and second slots in which the number of continuous slots is 2) in which the number of odd-numbered (first) continuous slots at the shortest distance in the circumferential direction X is relatively large with respect to a phase band (for example, fifth slot in which the number of continuous slots is 1) in which the number of continuous slots constituting a layer-phase band at the bottom (first layer) of the slot 32 is relatively small.

The continuous-pole coil group 10B for the (a+1)th lap ((a+1)=2, second lap) is configured only by b pieces (b=1) of the first pole coils 10e that are not interposed between the pair of adjacent-pole-connection same layer connection portions 11A when the number of blanks between the pole coils 10 is all odd (3). When the number of blanks is odd (3) in the continuous-pole coils 10d of the number of magnetic poles (8 poles)/c pieces (2 pieces because c=4), the continuous-pole coil connection portion 100 across the blanks electrically connects the layer of the slot 32 on the outermost radial side and the layer on the innermost radial side. The continuous-pole coil group 10B for the second lap and subsequent laps is shifted from the adjacent pole coil group 10A for the previous (first) lap in the direction opposite to the a-lap direction by one slot pitch.

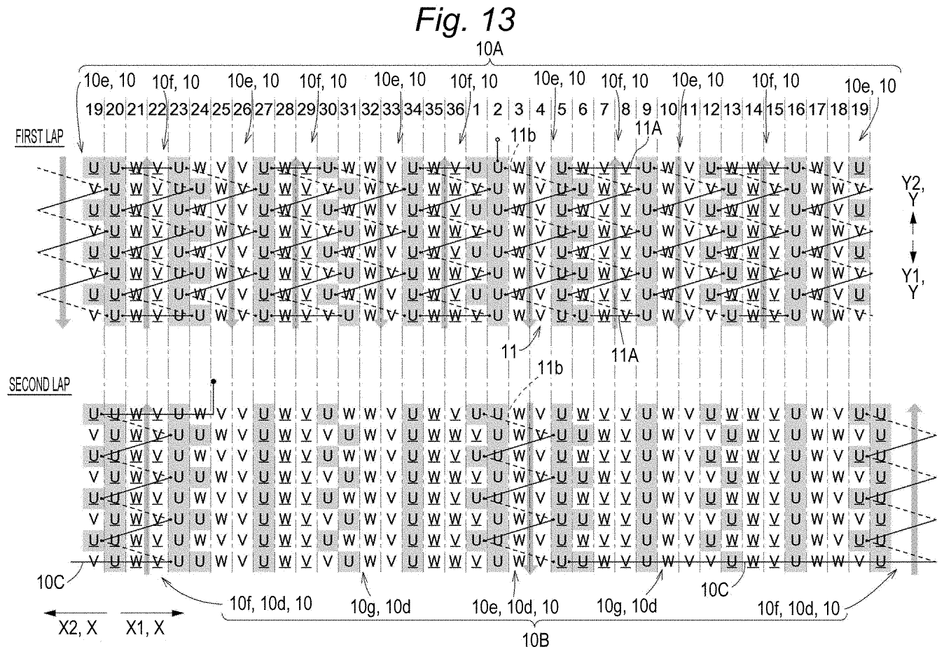

FIG. 13 illustrates the winding configuration of a motor M of 10 poles and 36 slots (Nspp=1.2, a=1, b=1, and c=5). Since the motor M of 10 poles and 36 slots has the number of slots per pole, which is 3.6, the short-section pitch is provided for three slots (short-section winding) or the long-section pitch is provided for four slots (long-section winding). In this embodiment, the unit coil 11 of the pole coil 10 is configured with the long-section pitch in which the turn coil end 11b (broken-line portion) is inclined or bent by one layer from the outer radial side to the inner radial side (Y1 direction) in the a-lap direction. As described above, the even-numbered layer of the slot 32 is configured by moving the odd-numbered layer of the slot 32 in the circumferential direction X by a predetermined slot number (here, 3 or 4) configured by an integer closest to the number of slots per pole. Here, when c is equal to or more than 4 (c=5), the movement direction of the even-numbered layer by the predetermined slot number with respect to the odd-numbered layer is the same direction (rotation direction X1) as the a-lap direction (rotation direction X1). The layer-phase band arrangement of even-numbered layers or the layer-phase band arrangement of the odd-numbered layers have the same configuration in the circumferential direction X.

As illustrated in FIG. 11, the coil for the a laps (a=1) is configured by an adjacent pole coil group 10A in which pole coils 10 in which the magnetic poles of the rotor 2 have the same phase as each other, and current directions are opposite to each other at the poles adjacent to each other among the magnetic poles of the rotor 2, that is, the current directions are the same as each other at the poles (one pole apart) of the magnetic poles of the rotor 2 are electrically connected to each other while being arranged to be adjacent to each other. In other words, the coil for the a laps is configured by the adjacent pole coil group 10A in which, in a state where pole coils 10 of which the number is equal to the number of magnetic poles of the rotor 2 are arranged to be adjacent to each other over an entire circumference of the stator 3, the pole coils 10 adjacent to each other in the circumferential direction X are electrically and sequentially connected to each other to make one lap. The coil of the (a+1)th lap ((a+1)=2, second lap) includes the continuous-pole coil group 10B in which the continuous-pole coils 10d of which the number is the number of magnetic poles (10 poles)/c pieces (2 pieces because c=5) are arranged in the circumferential direction X. The continuous-pole coil 10d includes b pieces (b=1) of pole coils 10 that face c pieces (c=5) of magnetic poles and are electrically connected. The continuous-pole coils 10d adjacent to each other in the circumferential direction X are electrically connected by the continuous-pole coil connection portion 100. In other words, the coil of the (a+1)th lap is configured by the continuous-pole coil group 10B in which the continuous-pole coil 10d is arranged in a range obtained by equally dividing the entire circumference of the stator 3 by the number of magnetic poles (10 poles)/c (2 equal parts because c=5), and the continuous-pole coils 10d of the number of magnetic poles (10 poles)/c pieces (2 pieces because c=5), which are adjacent to each other in the circumferential direction X are sequentially and electrically connected to each other and wound. In the continuous-pole coil, b pieces (b=1) of pole coils 10 and a pole coil missing portion 10g are adjacent to each other in no particular order, and the pole coils 10 that are closest to each other in the circumferential direction X are electrically connected. The pole coil missing portion is made of blanks corresponding to (c−b) pieces (c−b=4) of the pole coils 10.

In the adjacent pole coil group 10A constituting the coil for the a (a=1) laps, the first pole coil 10e and the second pole coil 10f are alternately arranged in the circumferential direction X. The first pole coil 10e is not interposed between a pair of adjacent-pole-connection same layer connection portions 11A that electrically connect pole coils 10 that are adjacent to each other and are arranged on the outermost radial side and the innermost radial side of the slot 32. The second pole coil 10f is interposed between a pair of adjacent-pole-connection same layer connection portions 11A. The adjacent-pole-connection same layer connection portion 11A that connects the same layers in the radial direction Y of the slots 32 is arranged on the outermost radial side and the innermost radial side of the slot 32. The phase starting end of the coil is pulled out from the slot 32 (second slot) at the end of a phase band on the a-lap direction side. In the phase band, the number of continuous slots being the number of slots 32 in which coil sides 11a that are continuous in the circumferential direction X and have the same phase are arranged at the bottom (first layer) of the slot 32 is the larger integer (2) of the integers (1 and 2) closest to Nspp (1.2). The phase band including the slot 32 for pulling out the phase starting end is a phase band (for example, first and second slots in which the number of continuous slots is 2) in which the number of odd-numbered (first) continuous slots at the shortest distance in the circumferential direction X is relatively large with respect to a phase band (for example, fifth slot in which the number of continuous slots is 1) in which the number of continuous slots constituting a layer-phase band at the bottom (first layer) of the slot 32 is relatively small.

The continuous-pole coil group 10B for the (a+1)th lap ((a+1)=2, second lap) is configured by the first pole coil 10e that is not interposed between the pair of adjacent-pole-connection same layer connection portions 11A, and the second pole coil 10f interposed between the pair of adjacent-pole-connection same layer connection portions 11A when the number of blanks between the pole coils 10 is all even (4). When the number of blanks is even (4) in the continuous-pole coils 10d of the number of magnetic poles (10 poles)/c pieces (2 pieces because c=5), the continuous-pole coil connection portion 10C across the blanks electrically connects the layers of the slots 32 on the innermost radial side. The continuous-pole coil group 10B for the second lap and subsequent laps is shifted from the adjacent pole coil group 10A for the previous (first) lap in the direction opposite to the a-lap direction by one slot pitch.

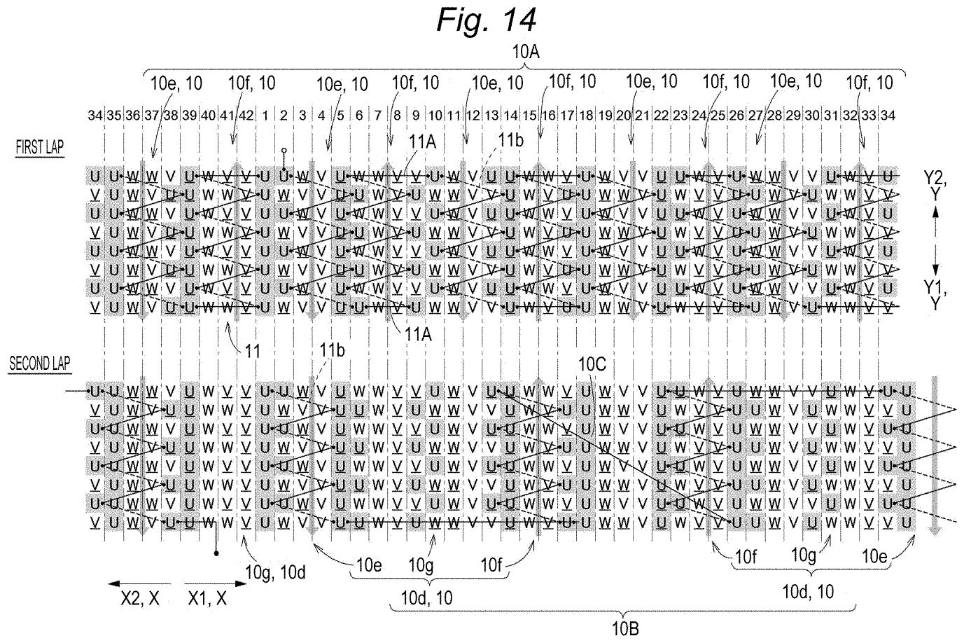

FIG. 14 illustrates the winding configuration of a motor M of 10 poles and 42 slots (Nspp=1.4, a=1, b=2, and c=5). Since the motor M of 10 poles and 42 slots has the number of slots per pole, which is 4.2, the short-section pitch is provided for four slots (short-section winding) or the long-section pitch is provided for five slots (long-section winding). In this embodiment, the unit coil 11 of the pole coil 10 is configured with the short-section pitch in which the turn coil end 11b (broken-line portion) is inclined or bent by one layer from the outer radial side to the inner radial side (Y1 direction) in the a-lap direction. As described above, the even-numbered layer of the slot 32 is configured by moving the odd-numbered layer of the slot 32 in the circumferential direction X by a predetermined slot number (here, 4 or 5) configured by an integer closest to the number of slots per pole. Here, when c is equal to or more than 4 (c=5), the movement direction of the even-numbered layer by the predetermined slot number with respect to the odd-numbered layer is the same direction (rotation direction X1) as the a-lap direction (rotation direction X1). The layer-phase band arrangement of even-numbered layers or the layer-phase band arrangement of the odd-numbered layers have the same configuration in the circumferential direction X.

As illustrated in FIG. 11, the coil for the a laps (a=1) is configured by an adjacent pole coil group 10A in which pole coils 10 in which the magnetic poles of the rotor 2 have the same phase as each other, and current directions are opposite to each other at the poles adjacent to each other among the magnetic poles of the rotor 2, that is, the current directions are the same as each other at the poles (one pole apart) of the magnetic poles of the rotor 2 are electrically connected to each other while being arranged to be adjacent to each other. In other words, the coil for a laps is configured by the adjacent pole coil group 10A in which, in a state where pole coils 10 of which the number is equal to the number of magnetic poles of the rotor 2 are arranged to be adjacent to each other over an entire circumference of the stator 3, the pole coils 10 adjacent to each other in the circumferential direction X are electrically and sequentially connected to each other to make one lap. The coil of the (a+1)th lap ((a+1)=2, second lap) includes the continuous-pole coil group 10B in which the continuous-pole coils 10d of which the number is the number of magnetic poles (10 poles)/c pieces (2 pieces because c=5) are arranged in the circumferential direction X. The continuous-pole coil 10d includes b pieces (b=2) of pole coils 10 that face c pieces (c=5) of magnetic poles and are electrically connected. The continuous-pole coils 10d adjacent to each other in the circumferential direction X are electrically connected by the continuous-pole coil connection portion 100. In other words, the coil of the (a+1)th lap is configured by the continuous-pole coil group 10B in which the continuous-pole coil 10d is arranged in a range obtained by equally dividing the entire circumference of the stator 3 by the number of magnetic poles (10 poles)/c (2 equal parts because c=5), and the continuous-pole coils 10d of the number of magnetic poles (10 poles)/c pieces (2 pieces because c=5), which are adjacent to each other in the circumferential direction X are sequentially and electrically connected to each other and wound. In the continuous-pole coil, b pieces (b=2) of pole coils 10 and a pole coil missing portion 10g are adjacent to each other in no particular order, and the pole coils 10 that are closest to each other in the circumferential direction X are electrically connected. The pole coil missing portion is made of blanks corresponding to (c−b) pieces (c−b=3) of the pole coils 10. Here, in the continuous-pole coil 10d, the closest pole coils 10 adjacent to each other in the circumferential direction X are electrically and sequentially connected when two or more pole coils 10 are provided.

In the adjacent pole coil group 10A constituting the coil for the a (a=1) laps, the first pole coil 10e and the second pole coil 10f are alternately arranged in the circumferential direction X. The first pole coil 10e is not interposed between a pair of adjacent-pole-connection same layer connection portions 11A that electrically connect pole coils 10 that are adjacent to each other and are arranged on the outermost radial side and the innermost radial side of the slot 32. The second pole coil 10f is interposed between a pair of adjacent-pole-connection same layer connection portions 11A. In the adjacent-pole-connection same layer connection portion 11A configured by the unit coil 11 including the turn coil end 11b connecting the same layers in the radial direction Y of the slots 32, the turn coil end 11b is arranged on the outermost radial side and the innermost radial side of the slot 32. The phase starting end of the coil is pulled out from the slot 32 (second slot) at the end of a phase band on the a-lap direction side. In the phase band, the number of continuous slots being the number of slots 32 in which coil sides 11a that are continuous in the circumferential direction X and have the same phase are arranged at the bottom (first layer) of the slot 32 is the larger integer (2) of the integers (1 and 2) closest to Nspp (1.4). The phase band including the slot 32 for pulling out the phase starting end is a phase band (for example, first and second slots in which the number of continuous slots is 2) in which the number of odd-numbered (first) continuous slots at the shortest distance in the circumferential direction X is relatively large with respect to a phase band (for example, fifth slot in which the number of continuous slots is 1) in which the number of continuous slots constituting a layer-phase band at the bottom (first layer) of the slot 32 is relatively small.

The continuous-pole coil group 10B for the (a+1)th lap ((a+1)=2, second lap) is configured by the first pole coil 10e that is not interposed between the pair of adjacent-pole-connection same layer connection portions 11A, and the second pole coil 10f interposed between the pair of adjacent-pole-connection same layer connection portions 11A when an odd number (1) and an even number (2) are mixed as the number of blanks between the pole coils 10. When the number of blanks is odd (1) in the continuous-pole coils 10d of the number of magnetic poles (10 poles)/c pieces (2 pieces because c=5), the continuous-pole coil connection portion 100 across the blanks electrically connects the layer of the slot 32 on the outermost radial side and the layer on the innermost radial side. When the number of blanks is even (2), the pole coil connection portion that sequentially and electrically connects the pole coils 10 in the continuous-pole coils 10d across the blanks connects the layers of the slots 32 on the outermost radial side (first layers of the 22th slot and the 34nd slot) with each other or the layers of the slots 32 on the innermost radial side (eighth layers of the fifth slot and the 17th slot). The continuous-pole coil group 10B for the second lap and subsequent laps is shifted from the adjacent pole coil group 10A for the previous (first) lap in the direction opposite to the a-lap direction by one slot pitch.

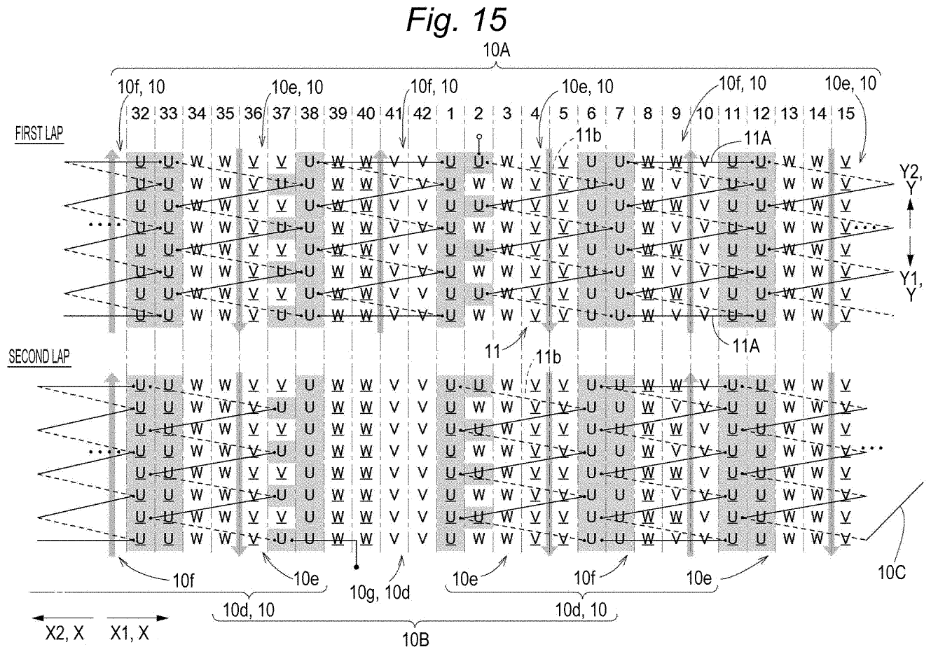

FIG. 15 illustrates the winding configuration of a motor M of 8 poles and 42 slots (Nspp=1.75, a=1, b=3, and c=4). Since the motor M of 8 poles and 42 slots has the number of slots per pole, which is 5.25, the short-section pitch is provided for five slots (short-section winding) or the long-section pitch is provided for six slots (long-section winding). In this embodiment, the unit coil 11 of the pole coil 10 is configured with the short-section pitch in which the turn coil end 11b (broken-line portion) is inclined or bent by one layer from the outer radial side to the inner radial side (Y1 direction) in the a-lap direction. As described above, the even-numbered layer of the slot 32 is configured by moving the odd-numbered layer of the slot 32 in the circumferential direction X by a predetermined slot number (here, 5 or 6) configured by an integer closest to the number of slots per pole. Here, when c is equal to or more than 4 (c=4), the movement direction of the even-numbered layer by the predetermined slot number with respect to the odd-numbered layer is the same direction (rotation direction X1) as the a-lap direction (rotation direction X1). The layer-phase band arrangement of even-numbered layers or the layer-phase band arrangement of the odd-numbered layers have the same configuration in the circumferential direction X.

As illustrated in FIG. 11, the coil for the a laps (a=1) is configured by an adjacent pole coil group 10A in which pole coils 10 in which the magnetic poles of the rotor 2 have the same phase as each other, and current directions are opposite to each other at the poles adjacent to each other among the magnetic poles of the rotor 2, that is, the current directions are the same as each other at the poles (one pole apart) of the magnetic poles of the rotor 2 are electrically connected to each other while being arranged to be adjacent to each other. In other words, the coil for a laps is configured by the adjacent pole coil group 10A in which, in a state where pole coils 10 of which the number is equal to the number of magnetic poles of the rotor 2 are arranged to be adjacent to each other over an entire circumference of the stator 3, the pole coils 10 adjacent to each other in the circumferential direction X are electrically and sequentially connected to each other to make one lap. The coil of the (a+1)th lap ((a+1)=2, second lap) includes the continuous-pole coil group 10B in which the continuous-pole coils 10d of which the number is the number of magnetic poles (8 poles)/c pieces (2 pieces because c=4) are arranged in the circumferential direction X. The continuous-pole coil 10d includes b pieces (b=3) of pole coils 10 that face c pieces (c=4) of magnetic poles and are electrically connected. The continuous-pole coils 10d adjacent to each other in the circumferential direction X are electrically connected by the continuous-pole coil connection portion 100. In other words, the coil of the (a+1)th lap is configured by the continuous-pole coil group 10B in which the continuous-pole coil 10d is arranged in a range obtained by equally dividing the entire circumference of the stator 3 by the number of magnetic poles (8 poles)/c (2 equal parts because c=4), and the continuous-pole coils 10d of the number of magnetic poles (8 poles)/c pieces (2 pieces because c=4), which are adjacent to each other in the circumferential direction X are sequentially and electrically connected to each other and wound. In the continuous-pole coil, b pieces (b=3) of pole coils 10 and a pole coil missing portion 10g are adjacent to each other in no particular order, and the pole coils 10 that are closest to each other in the circumferential direction X are electrically connected. The pole coil missing portion is made of blanks corresponding to (c−b) pieces (c−b=1) of the pole coils 10. Here, in the continuous-pole coil 10d, the closest pole coils 10 adjacent to each other in the circumferential direction X are electrically and sequentially connected when two or more (b=3) pole coils 10 are provided.

In the adjacent pole coil group 10A constituting the coil for the a (a=1) laps, the first pole coil 10e and the second pole coil 10f are alternately arranged in the circumferential direction X. The first pole coil 10e is not interposed between a pair of adjacent-pole-connection same layer connection portions 11A that electrically connect pole coils 10 that are adjacent to each other and are arranged on the outermost radial side and the innermost radial side of the slot 32. The second pole coil 10f is interposed between a pair of adjacent-pole-connection same layer connection portions 11A. In the adjacent-pole-connection same layer connection portion 11A configured by the unit coil 11 including the turn coil end 11b connecting the same layers in the radial direction Y of the slots 32, the turn coil end 11b is arranged on the outermost radial side and the innermost radial side of the slot 32. The phase starting end of the coil is pulled out from the slot 32 (second slot) at the end of a phase band on the a-lap direction side. In the phase band, the number of continuous slots being the number of slots 32 in which coil sides 11a that are continuous in the circumferential direction X and have the same phase are arranged at the bottom (first layer) of the slot 32 is the larger integer (2) of the integers (1 and 2) closest to Nspp (1.75). The phase band including the slot 32 for pulling out the phase starting end is a phase band (for example, first and second slots in which the number of continuous slots is 2) in which the number of odd-numbered (first) continuous slots at the shortest distance in the circumferential direction X is relatively large with respect to a phase band (for example, 38th slot in which the number of continuous slots is 1) in which the number of continuous slots constituting a layer-phase band at the bottom (first layer) of the slot 32 is relatively small.

The continuous-pole coil group 10B for the (a+1)th lap ((a+1)=2, second lap) is configured by the first pole coil 10e that is not interposed between the pair of adjacent-pole-connection same layer connection portions 11A, and the second pole coil 10f interposed between the pair of adjacent-pole-connection same layer connection portions 11A when an odd number (1) and an even number (0) are mixed as the number of blanks between the pole coils 10. When the number of blanks is odd (1) in the continuous-pole coils 10d of the number of magnetic poles (8 poles)/c pieces (2 pieces because c=4), the continuous-pole coil connection portion 100 across the blanks electrically connects the layer of the slot 32 on the outermost radial side and the layer on the innermost radial side. The continuous-pole coil group 10B for the second lap and subsequent laps is shifted from the adjacent pole coil group 10A for the previous (first) lap in the direction opposite to the a-lap direction by one slot pitch.

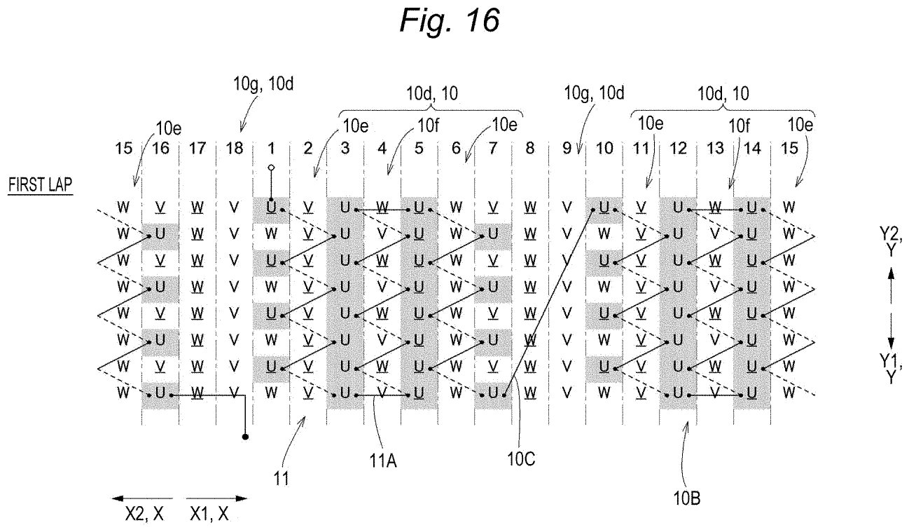

FIG. 16 illustrates the winding configuration of a motor M of 8 poles and 18 slots (Nspp=0.75, a=0, b=3, and c=4). Since the motor M of 8 poles and 18 slots has the number of slots per pole, which is 2.25, the short-section pitch is provided for two slots (short-section winding) or the long-section pitch is provided for three slots (long-section winding). In this embodiment, the unit coil 11 of the pole coil 10 is configured with the short-section pitch in which the turn coil end 11b (broken-line portion) is inclined or bent by one layer from the outer radial side to the inner radial side (Y1 direction) in the (a+1)-lap direction. As described above, the even-numbered layer of the slot 32 is configured by moving the odd-numbered layer of the slot 32 in the circumferential direction X by a predetermined slot number (here, 2 or 3) configured by an integer closest to the number of slots per pole. Here, when c is equal to or more than 4 (c=4), the movement direction of the even-numbered layer by the predetermined slot number with respect to the odd-numbered layer is the same direction (rotation direction X1) as the (a+1)-lap direction (rotation direction X1). The layer-phase band arrangement of even-numbered layers or the layer-phase band arrangement of the odd-numbered layers have the same configuration in the circumferential direction X.

As illustrated in FIG. 16, there is no coil for the a laps (a=0). The coil of the (a+1)th lap ((a+1)=1, first lap) includes the continuous-pole coil group 10B in which the continuous-pole coils 10d of which the number is the number of magnetic poles (8 poles)/c pieces (2 pieces because c=4) are arranged in the circumferential direction X. The continuous-pole coil 10d includes b pieces (b=3) of pole coils 10 that face c pieces (c=4) of magnetic poles and are electrically connected. The continuous-pole coils 10d adjacent to each other in the circumferential direction X are electrically connected by the continuous-pole coil connection portion 100. In other words, the coil of the (a+1)th lap is configured by the continuous-pole coil group 10B in which the continuous-pole coil 10d is arranged in a range obtained by equally dividing the entire circumference of the stator 3 by the number of magnetic poles (8 poles)/c (2 equal parts because c=4), and the continuous-pole coils 10d of the number of magnetic poles (8 poles)/c pieces (2 pieces because c=4), which are adjacent to each other in the circumferential direction X are sequentially and electrically connected to each other and wound. In the continuous-pole coil, b pieces (b=3) of pole coils 10 and a pole coil missing portion 10g are adjacent to each other in no particular order, and the pole coils 10 that are closest to each other are electrically connected. The pole coil missing portion is made of blanks corresponding to (c−b) pieces (c−b=1) of the pole coils 10. The phase starting end of the coil is pulled out from the slot 32 (first slot) at the end of a phase band on the (a+1)-lap direction side. In the phase band, the number of continuous slots being the number of slots 32 in which coil sides 11a that are continuous in the circumferential direction X and have the same phase are arranged at the bottom (first layer) of the slot 32 is the larger integer (1) of the integers (0 and 1) closest to Nspp (0.75). The phase band including the slot 32 for pulling out the phase starting end is a phase band (for example, first slot in which the number of continuous slots is 1) in which the number of odd-numbered (first) continuous slots at the shortest distance in the circumferential direction X is relatively large with respect to a phase band (for example, intermediate central portion between the 16th slot and the 17th slot in which the number of continuous slots is 0 (that is, in the original phase arrangement order, the phases are arranged in order of the U phase, the V phase, and the W phase in a right direction in FIG. 16 (for example, first layers of slots having the slot numbers of 1 to 3), but, with Nspp (0.75), the three-phase configuration arrangement is established by omitting the U phase which is to be normally arranged between the V phase of the 16th slot and the W phase of the 17th slot, that is, setting the U phase to 0. Thus, the virtual slot position of the omitted U phase in which the number of continuous slots is 0 is the intermediate central portion between the third slot and the fourth slot) in which the number of continuous slots constituting a layer-phase band at the bottom (first layer) of the slot 32 is relatively small.

The continuous-pole coil group 10B for the (a+1)th lap ((a+1)=1, first lap) is configured by the first pole coil 10e that is not interposed between the pair of adjacent-pole-connection same layer connection portions 11A, and the second pole coil 10f interposed between the pair of adjacent-pole-connection same layer connection portions 11A when an odd number (1) and an even number (0) are mixed as the number of blanks between the pole coils 10. When the number of blanks is odd (1) in the continuous-pole coils 10d of the number of magnetic poles (8 poles)/c pieces (2 pieces because c=4), the continuous-pole coil connection portion 100 across the blanks electrically connects the layer of the slot 32 on the outermost radial side and the layer on the innermost radial side.

As described above, in the motor M in this embodiment, in the fractional slot configuration in which the number of slots per pole and phase is more than ½, and the denominator is equal to or more than 2, the coil for a laps is configured by the adjacent pole coil group 10A in which, in a state where pole coils 10 of which the number is equal to the number of magnetic poles of the rotor 2 are arranged to be adjacent to each other over an entire circumference of the stator 3, the pole coils 10 adjacent to each other in the circumferential direction X are electrically and sequentially connected to each other to make one lap. In the adjacent pole coil group 10A constituting the coil for the a laps, the first pole coil 10e and the second pole coil 10f are alternately arranged in the circumferential direction X. The first pole coil 10e is not interposed between a pair of adjacent-pole-connection same layer connection portions 11A that electrically connect pole coils 10 that are adjacent to each other and are arranged on the outermost radial side and the innermost radial side of the slot 32. The second pole coil 10f is interposed between a pair of adjacent-pole-connection same layer connection portions 11A. The phase starting end of the coil is pulled out from the slot 32 at the end of a phase band on the a-lap direction side ((a+1)-lap direction when a=0). In the phase band, the number of continuous slots being the number of slots 32 in which coil sides 11a that are continuous in the circumferential direction X and have the same phase are arranged at the bottom (first layer) of the slot 32 is the larger integer closest to Nspp. The phase band including the slot 32 for pulling out the phase starting end is a phase band (the number of continuous slots is 1 when a=0) in which the number of odd-numbered continuous slots at the shortest distance in the circumferential direction X is relatively large with respect to a phase band (blank in which the number of continuous slots is 0 when a=0) in which the number of continuous slots constituting a layer-phase band at the bottom (first layer) of the slot 32 is relatively small.

In the motor M in this embodiment, in the fractional slot configuration in which the number of slots per pole and phase is more than ½, and the denominator is equal to or more than 2, the coil of the (a+1)th lap is configured by the continuous-pole coil group 10B in which the continuous-pole coil 10d is arranged in a range obtained by equally dividing the entire circumference of the stator 3 by the number of magnetic poles/c, and the continuous-pole coils 10d of the number of magnetic poles/c pieces, which are adjacent to each other in the circumferential direction X are sequentially and electrically connected to each other and wound. In the continuous-pole coil, b pieces of pole coils 10 and a pole coil missing portion 10g are adjacent to each other in no particular order. The pole coil missing portion is made of blanks corresponding to (c−b) pieces of the pole coils 10. When the number of blanks between the pole coils 10 is all odd, the continuous-pole coil group 10B for the (a+1)th lap is configured only by the first pole coil 10e that is not interposed between the pair of adjacent-pole-connection same layer connection portions 11A. When the number of blanks between the pole coils 10 is all even or when an odd number and an even number (including zero) are mixed as the number of blanks between the pole coils 10, the continuous-pole coil group 10B for the (a+1)th lap is configured by the first pole coil 10e that is not interposed between the pair of adjacent-pole-connection same layer connection portions 11A and the second pole coil 10f interposed between the pair of adjacent-pole-connection same layer connection portions 11A. Further, the pole coil connection portion that sequentially and electrically connects the pole coils 10 in the continuous-pole coils 10d across the blanks or the pole coil connection portion (continuous-pole coil connection portion 100) that sequentially and electrically connects the pole coils 10 between the continuous-pole coils 10d connects the layer of the slots 32 on the outermost radial side and the layer of the slots 32 on the innermost radial side when the number of blanks is odd, and connects the layers of the slots 32 on the outermost radial side with each other or the layers of the slots 32 on the innermost radial side when the number of blanks is even (not including zero).

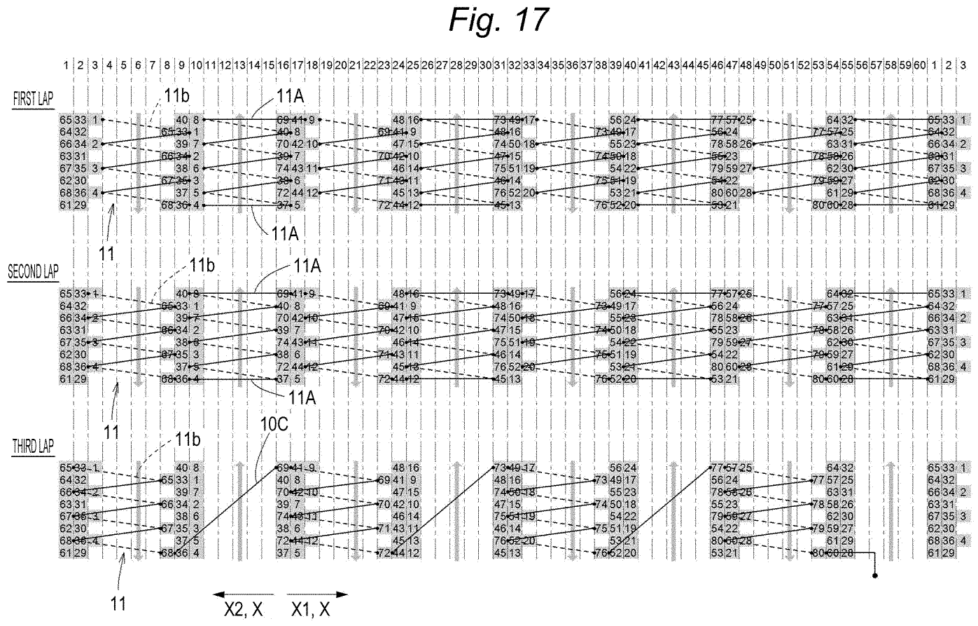

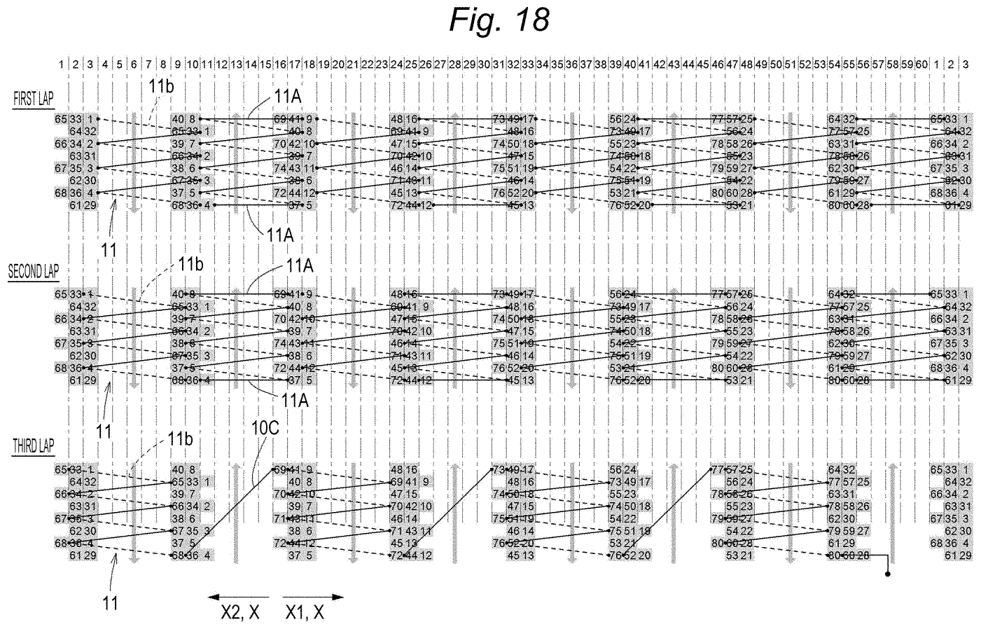

A point that, in a motor M of 8 poles and 60 slots, in the pole coil 10 that occupies most of the windings, the turn coil end 11b of the unit coil 11 may take both the short-section pitch and the long-section pitch will be described below with reference to FIGS. 17 and 18. The numbers in the upper part in FIGS. 17 and 18 indicate the slot numbers. The white circles in FIGS. 17 and 18 indicate the winding start end. The black circles in FIGS. 17 and 18 indicate the winding termination. The number in the colored part in FIGS. 17 and 18 indicates the turn order of the U phase. The solid line indicates the coil arranged on the upper surface of the stator 3. The broken line indicates the coil arranged on the lower surface of the stator 3.

FIG. 17 corresponds to FIGS. 3 to 5. In the pole coil 10, the turn coil end 11b (broken line) of the unit coil 11 is configured with the short-section pitch (7 slot pitches). In FIG. 18, in the pole coil 10, the turn coil end 11b (broken line) of the unit coil 11 is configured with the long-section pitch (8 slot pitches).

In FIG. 18, the configuration is made with a phase band arrangement in which the four sets of two-layer units 11U illustrated in FIG. 17 are shifted in the rotation direction X1 by the long-section pitch (8 slot pitches), and the two layers of the two-layer unit 11U in each set are replaced in the radial direction Y. FIG. 18 illustrates the optimum turn order of the unit coils 11 in this phase band arrangement.

In the first turn to the second turn as a portion of the start turn of the first lap, in the unit coil 11 not for the adjacent-pole-connection same layer connection portion 11A on the outermost radial side, the coil side 11a is inserted into the third layer of the third slot and the second layer of the 11th slot so that the coil side connection portion 11c being one coil end is arranged above the stator 3. The coil side 11a for the half turn, which is the remaining portion of the start turn of the first lap, is inserted into the first layer of the third slot, and one end of the coil side is connected with the coil side located on the other end side of the coil side connection portion 11c for the first turn to the second turn, by welding or the like. In this manner, the turn coil end 11b of the first turn is formed. That is, differing from FIG. 17, the turn coil end 11b (broken line) of the unit coil 11 in the pole coil 10 has a long-section pitch (8 slot pitches).

The pole coil 10 similar to that in the first turn to the second turn continues from the second turn to the fourth turn. In the fourth turn to the fifth turn, in the unit coil 11 for the adjacent-pole-connection same layer connection portion 11A on the innermost radial side, the coil side 11a is inserted into the eighth layer of the 11th slot and the eighth layer of the 18th slot so that the coil side connection portion 11c being one coil end is arranged above the stator 3. That is, the adjacent-pole-connection same layer connection portion 11A on the innermost radial side has a short-section pitch (7 slot pitches) as in FIG. 17. The pole coil 10 of the long-section pitch (8 slot pitches) similar to that in the first turn to the second turn continues from the fifth turn to the eighth turn. The turns of the first turn to the eighth turn are repeated from the ninth turn to the 16th turn, from the 17th turn to the 24th turn, and from the 25th turn to the 32nd turn.

In the 32nd turn to the 33rd turn as a portion of the start turn of the second lap, in the unit coil 11 for the adjacent-pole-connection same layer connection portion 11A on the outermost radial side (lap change portion), the coil side 11a is inserted into the first layer of the 55th slot and the first layer of the second slot so that the coil side connection portion 11c being one coil end is arranged above the stator 3. That is, the turn coil end 11b of the unit coil 11 at the adjacent-pole-connection same layer connection portion 11A on the outermost radial side (lap change portion) has a short-section pitch (7 slot pitches) as in FIG. 17. The second lap is completed by repeating turns of the 33rd turn to a 64th turn in a similar manner to that for the turns of the first turn to the 32nd turn.

In the 64th turn to the 65th turn as a portion of the start turn of the third lap, in the unit coil 11 for the continuous-pole coil connection portion 100, the coil side 11a is inserted into the first layer of the 54th slot and the first layer of the first slot so that the coil side connection portion 11c being one coil end is arranged above the stator 3.

Turns of the 65th turn to the 68th turn are repeated in the similar manner to that for the above-described turns of the first turn to the fourth turn. Turns of the 69th turn to the 72nd turn and turns of the 73rd turn to the 76th turn are repeated in the similar manner to that for the turns of the 65th turn to the 68th turn. Turns of the 77th turn to the 79th turn are made in the similar manner to that for the turns of the 65th turn to the 67th turn. Finally, the turn coil end 11b for the 80th turn is formed by connecting one liner end of the coil side 11a for the half turn with a coil end located on one end side of the coil side connection portion 11c for the 79th turn to the 80th turn by welding or the like. The tip of the other linear end of the coil side 11a for the half turn is electrically connected to the neutral point as the phase termination.

As described above, in the phase band arrangement illustrated in FIG. 18, all the turn coil ends 11b have a long-section pitch. The turn coil end 11b is inclined by one layer from the outer radial side of the slot 32 to the inner radial side (Y1 direction) in the a-lap direction (schematic diagram illustrated, practically, bent as illustrated in FIG. 7 and the like). The adjacent-pole-connection same layer connection portion 11A and the continuous-pole coil connection portion 100 of the unit coil 11 for 10 adjacent-pole-connection same layer connection portions 11A on the innermost radial side and the outermost radial side (lap change portion), and the unit coil 11 for three continuous-pole coil connection portions 100 are coil side connection portions 11c of the short-section pitch. The slot pitch of the coil side connection portion 11c except for these is the long-section pitch. That is, of the total number 159 of coil ends, 146 have the long-section pitch. Thus, with the phase band arrangement illustrated in FIG. 17 similar to FIGS. 3 to 6, it is possible to minimize the total coil length and reduce the manufacturing cost.

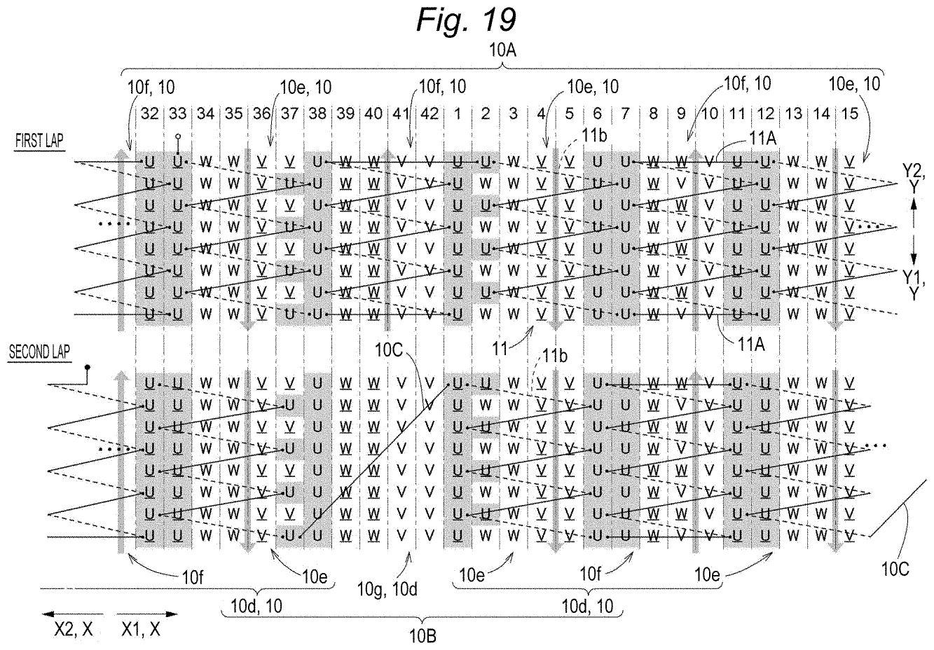

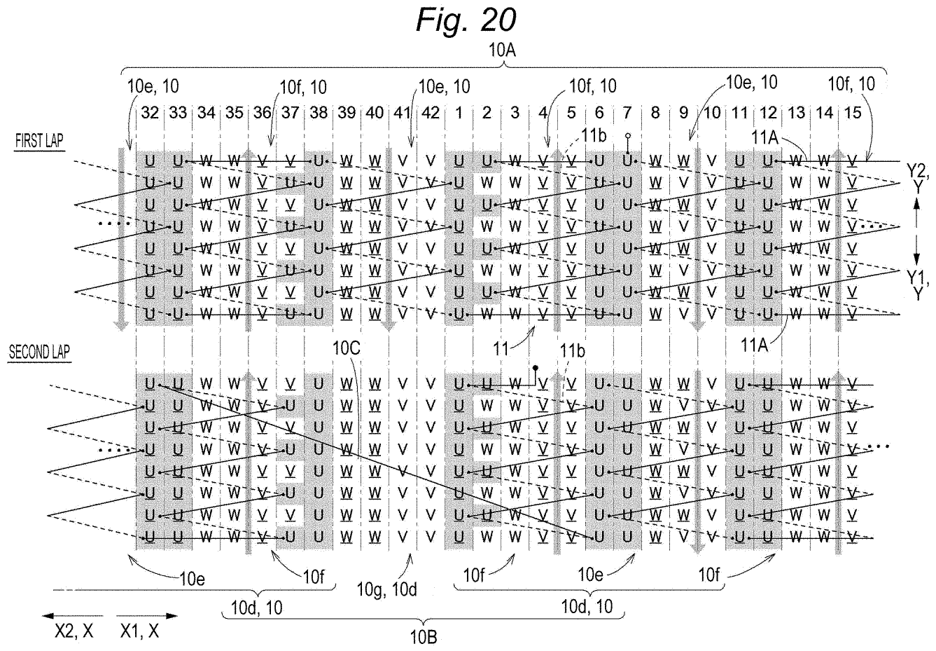

With reference to FIGS. 19 and 20, the phase starting end position of the coil will be verified as a modification example of the winding configuration of the motor M with 8 poles and 42 slots (Nspp=1.75, a=1, b=3, c=4) illustrated in FIG. 15. In any case, the phase starting end of the coil illustrated in FIGS. 19 and 20 is pulled out from the slot 32 (33rd slot in FIG. 19, 7th slot in FIG. 20) at the end of a phase band on the a-lap direction side. In the phase band, the number of continuous slots being the number of slots 32 in which coil sides 11a that are continuous in the circumferential direction X and have the same phase are arranged at the bottom (first layer) of the slot 32 is the larger integer (2) of the integers (1 and 2) closest to Nspp (1.75).

In FIG. 19, the phase band including the slot 32 for pulling out the phase starting end is a phase band (32nd and 33rd slots in which the number of continuous slots is 2) in which the number of odd-numbered (first) continuous slots at the shortest distance in the circumferential direction X is relatively large with respect to a phase band (38th slot in which the number of continuous slots is 1) in which the number of continuous slots constituting a layer-phase band at the bottom (first layer) of the slot 32 is relatively small. In FIG. 20, the phase band including the slot 32 for pulling out the phase starting end is a phase band (sixth and seventh slots in which the number of continuous slots is 2) in which the number of even-numbered (second) continuous slots in the circumferential direction X is relatively large with respect to a phase band (38th slot in which the number of continuous slots is 1) in which the number of continuous slots constituting a layer-phase band at the bottom (first layer) of the slot 32 is relatively small.

In all the above-described embodiments, among the pole coils 10 constituting the phase coil, the first pole coil 10e that is not interposed between the pair of adjacent-pole-connection same layer connection portions 11A is a pole coil 10 of an odd number counting from the phase starting end. The second pole coil 10f interposed between the pair of adjacent-pole-connection same layer connection portions 11A is a pole coil 10 of an even number counting from the phase starting end. Here, the circumferential direction X of one pole coil 10 means going back and forth at a predetermined coil pitch. In the depth direction (radial direction Y) of the slot 32, the layers adjacent in the same direction are sequentially joined. In the arrangement of the layer-phase band in the depth direction of the slot 32, the even-numbered layer from the bottom of the slot 32 with respect to the odd-numbered layer is moved in the circumferential direction X by the number of slots, which is any one of integers closest to the number of slots per pole (Nspp×3). Here, the layer-phase band arrangement of the odd-numbered layers and the layer-phase band arrangement of the even-numbered layers are the same in the circumferential direction X.

In such a winding configuration, in the examples of FIGS. 15 and 19, the coil end length of the continuous-pole coil connection portion 100 is equivalent to one pole coil 10. In the example of FIG. 20, the coil end length of the continuous-pole coil connection portion 100 is equivalent to three pole coils 10. Thus, in the examples illustrated in FIGS. 15 and 19, it is possible to reduce the coil end length. That is, the phase band including the slot 32 for pulling out the phase starting end is preferably a phase band in which the number of odd-numbered continuous slots at the shortest distance in the circumferential direction X is relatively large with respect to a phase band in which the number of continuous slots constituting a layer-phase band at the bottom (first layer) of the slot 32 is relatively small. Further, in the example illustrated in FIG. 15, it is more possible to set one of the continuous-pole coil connection portions 100 as the phase termination. That is, the example illustrated in FIG. 15 is more preferable because the total number of continuous-pole coil connection portions 100 can be reduced by one. That is, the phase band including the slot 32 for pulling out the phase starting end is more preferably a phase band in which the number of odd-numbered continuous slots at the shortest distance in the a-lap direction is relatively large with respect to a phase band in which the number of continuous slots constituting a layer-phase band at the bottom (first layer) of the slot 32 is relatively small.

The characteristic configuration of the rotary electric machine according to this disclosure is that a rotary electric machine includes a stator that has a plurality of slots accommodating a coil having a heavy winding configuration made of a segment conductor, and a rotor that faces the stator and has a plurality of magnetic poles, and has a fractional slot configuration in which the number of slots per pole and phase, which is obtained by dividing the number of the slots of the stator by the number of phases and the number of the magnetic poles of the rotor, is more than ½, and a denominator is equal to or more than 2 in an irreducible fraction expression. When the irreducible fraction expression of the number of slots per pole and phase is set as (a+b/c) where a indicates zero or a positive integer, and b and c indicate a positive integer and b<c, the coil for a laps is configured by an adjacent pole coil group in which pole coils adjacent to each other in a circumferential direction are electrically and sequentially connected to each other while the pole coils are arranged to be adjacent to each other over an entire circumference of the stator, the pole coils of which the number is equal to the number of magnetic poles of the rotor, the coil of a (a+1)th lap is configured by a continuous-pole coil group in which a continuous-pole coil is arranged in a range obtained by equally dividing the entire circumference by the number of magnetic poles/c, and the continuous-pole coils of the number of magnetic poles/c, which are adjacent to each other in the circumferential direction are sequentially and electrically connected to each other and wound, the continuous-pole coil in which b pieces of pole coils and a pole coil missing portion are adjacent to each other in no particular order, and the pole coils that are closest to each other in the circumferential direction are electrically connected, and the pole coil missing portion being made of blanks corresponding to (c−b) pieces of the pole coils, in the adjacent pole coil group, the pole coil that is not interposed between a pair of adjacent-pole-connection same layer connection portions that electrically connect the coils that are arranged on the outermost radial side and the innermost radial side of the slot and adjacent to each other, and the pole coil interposed between the pair of adjacent-pole-connection same layer connection portions are alternately arranged in the circumferential direction, and the continuous-pole coil group is configured only by the pole coil that is not interposed between the pair of adjacent-pole-connection same layer connection portions when the number of blanks between the pole coils is all odd, and configured by the pole coil that is not interposed between the pair of adjacent-pole-connection same layer connection portions and the pole coil interposed between the pair of adjacent-pole-connection same layer connection portions when the number of blanks between the pole coils is all even (including zero) or when an odd number and an even number (including zero) are mixed as the number of blanks between the pole coils, where the a laps are made in the same direction.

With this configuration, it is possible to realize a rotary electric machine having a fractional slot configuration using a segment conductor, with a heavy winding configuration. In this configuration, since it is possible to share the unit coil of the pole coil that occupies most of the pole coil, it is possible to reduce the manufacturing cost.

Still another characteristic configuration is that the adjacent pole coil group or the continuous-pole coil group in the second lap and subsequent laps are shifted from the adjacent pole coil group in the previous lap by one slot pitch in the direction opposite to the a-lap direction.

With this configuration, the coil ends are evenly arranged, and it is possible to achieve compactness.

Another characteristic configuration is that when layers are counted in ascending order toward an opening portion of the slot with a bottom layer of the slot as 1, as a layer-phase band arrangement in a radial direction of the slot, an even-numbered layer is configured by moving an odd-numbered layer in the circumferential direction by a predetermined slot number configured by an integer closest to the number of slots per pole, which is obtained by multiplying the number of slots per pole and phase by the number of phases, a movement direction of the even-numbered layer to the odd-numbered layer by the predetermined slot number is opposite to the a-lap direction ((a+1)-lap direction when a=0) when c is equal to or more than 4, the layer-phase band arrangement of the even-numbered layers and layer-phase band arrangement of the odd-numbered layers have the same configuration in the circumferential direction, and a phase starting end of the coil is pulled out from the slot at an end of a phase band on the a-lap direction side ((a+1)-lap direction side when a=0), the phase band in which the number of continuous slot is larger one of integers closest to the number of slots per pole and phase, and the number of continuous slots being the number of slots in which the coil sides that have the same phase and are continuous in the circumferential direction at the bottom of the slots are arranged.

With this configuration, it is possible to realize a rotary electric machine having a fractional slot configuration using a segment conductor, with a heavy winding configuration.

Still yet another characteristic configuration is that the phase band including the slot for pulling out the phase starting end is a phase band (the number of continuous slots is 1 when a=0) in which the number of the odd-numbered continuous slots at the shortest distance in the circumferential direction is relatively large with respect to a phase band (the blank in which the number of continuous slots is zero when a=0) in which the number of continuous slots constituting a layer-phase band at the bottom of the slot is relatively small.

With this configuration, in the coil of the (a+1)th lap, it is possible to reduce the coil end length for electrically connecting the pole coils in the continuous-pole coils across the blank or the pole coils between the continuous-pole coils.

Still yet another characteristic configuration is that the circumferential direction is the a-lap direction ((a+1)-lap direction when a=0).

With this configuration, in the coil of the (a+1)th lap, it is possible to reduce the coil end length for electrically connecting the pole coils in the continuous-pole coils across the blank or the pole coils between the continuous-pole coils.

Still yet another characteristic configuration is that the adjacent-pole-connection same layer connection portion is arranged on the outermost radial side and the innermost radial side of the slot.

As with this configuration, when the adjacent-pole-connection same layer connection portion is arranged on the outermost radial side and the innermost radial side, it is possible to arrange the adjacent-pole-connection same layer connection portion without the interference with the coil ends of the adjacent pole coil group and the continuous-pole coil group, and to achieve the compactness.

Still yet another characteristic configuration is that a pole coil connection portion that sequentially and electrically connects the pole coils in the continuous-pole coils across the blanks or between the continuous-pole coils connects a layer of the slot on the outermost radial side and a layer of the slot on the innermost radial side when the number of blanks crossed by the pole coil connection portion is odd, and connects the layers of the slot on the outermost radial side with each other or the layers of the slot on the innermost radial side with each other when the number of blanks crossed by the pole coil connection portion is even (not including zero).

With this configuration, the coil ends of the continuous-pole coil group are evenly arranged, and it is possible to achieve the compactness.

Still yet another characteristic configuration is that the segment conductor includes a pair of coil sides accommodated in the two slots and one turn coil end that electrically connects the pair of coil sides and is arranged at a coil end, and the turn coil end of the pole coil is configured, in the a-lap direction ((a+1)-lap direction when a=0), at a short-section pitch of being inclined or bent by one layer from an outer radial side to an inner radial side of the slot.

As with this configuration, when the turn coil end of the pole coil that occupies the most of the components has the short-section pitch, it is possible to reduce the total coil length and reduce the manufacturing cost.

### Other Embodiments

(1) The two-layer unit 11U in the above-described embodiment is not limited to four sets, and one or more sets may be provided.

(2) The motor M in the above-described embodiment is not limited to the three-phase AC synchronous motor, and may be an AC motor, an induction motor, a synchronous motor, or the like having any number of phases.

This disclosure can be applied to a rotary electric machine having a fractional slot configuration having a coil configured by segment conductors.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A rotary electric machine comprising:
a stator that has a plurality of slots accommodating a coil having a heavy winding configuration made of a segment conductor; and
a rotor that faces the stator and has a plurality of magnetic poles,
the rotary electric machine having a fractional slot configuration in which the number of slots per pole and phase, which is obtained by dividing the number of the slots of the stator by the number of phases and the number of the magnetic poles of the rotor, is more than ½, and a denominator is equal to or more than 2 in an irreducible fraction expression, wherein
when the irreducible fraction expression of the number of slots per pole and phase is set as (a+b/c) where a indicates zero or a positive integer, and b and c indicate a positive integer and b<c,
the coil for a laps is configured by an adjacent pole coil group in which pole coils adjacent to each other in a circumferential direction are electrically and sequentially connected to each other while the pole coils are arranged to be adjacent to each other over an entire circumference of the stator, the pole coils of which the number is equal to the number of magnetic poles of the rotor,
the coil of a (a+1)th lap is configured by a continuous-pole coil group in which a continuous-pole coil is arranged in a range obtained by equally dividing the entire circumference by the number of magnetic poles/c, and the continuous-pole coils of the number of magnetic poles/c, which are adjacent to each other in the circumferential direction are sequentially and electrically connected to each other and wound, the continuous-pole coil in which b pieces of pole coils and a pole coil missing portion are adjacent to each other in no particular order, and the pole coils that are closest to each other in the circumferential direction are electrically connected, and the pole coil missing portion being made of blanks corresponding to (c−b) pieces of the pole coils,
in the adjacent pole coil group, the pole coil that is not interposed between a pair of adjacent-pole-connection same layer connection portions that electrically connect the coils that are arranged on the outermost radial side and the innermost radial side of the slot and adjacent to each other, and the pole coil interposed between the pair of adjacent-pole-connection same layer connection portions are alternately arranged in the circumferential direction, and
the continuous-pole coil group is
configured only by the pole coil that is not interposed between the pair of adjacent-pole-connection same layer connection portions when the number of blanks between the pole coils is all odd, and
configured by the pole coil that is not interposed between the pair of adjacent-pole-connection same layer connection portions and the pole coil interposed between the pair of adjacent-pole-connection same layer connection portions when the number of blanks between the pole coils is all even (including zero) or when an odd number and an even number (including zero) are mixed as the number of blanks between the pole coils, where the a laps are made in the same direction.

2. The rotary electric machine according to claim 1, wherein
the adjacent pole coil group or the continuous-pole coil group in a second lap and subsequent laps are shifted from the adjacent pole coil group in a previous lap by one slot pitch in a direction opposite to an a-lap direction.

3. The rotary electric machine according to claim 1, wherein
when layers are counted in ascending order toward an opening portion of the slot with a bottom layer of the slot as 1, as a layer-phase band arrangement in a radial direction of the slot, an even-numbered layer is configured by moving an odd-numbered layer in the circumferential direction by a predetermined slot number configured by an integer closest to the number of slots per pole, which is obtained by multiplying the number of slots per pole and phase by the number of phases,
a movement direction of the even-numbered layer to the odd-numbered layer by the predetermined slot number is the same as the a-lap direction ((a+1)-lap direction when a=0) when c is equal to or more than 4,
the layer-phase band arrangement of the even-numbered layers and layer-phase band arrangement of the odd-numbered layers have the same configuration in the circumferential direction, and
a phase starting end of the coil is pulled out from the slot at an end of a phase band on the a-lap direction side ((a+1)-lap direction side when a=0), the phase band in which the number of continuous slot is larger one of integers closest to the number of slots per pole and phase, and the number of continuous slots being the number of slots in which the coil sides that have the same phase and are continuous in the circumferential direction at the bottom of the slots are arranged.

4. The rotary electric machine according to claim 3, wherein
a phase band including the slot for pulling out the phase starting end is a phase band (the number of continuous slots is 1 when a=0) in which the number of the odd-numbered continuous slots at the shortest distance in the circumferential direction is relatively large with respect to a phase band (the blank in which the number of continuous slots is zero when a=0) in which the number of continuous slots constituting a layer-phase band at the bottom of the slot is relatively small.

5. The rotary electric machine according to claim 4, wherein
the circumferential direction is the a-lap direction ((a+1)-lap direction when a=0).

6. The rotary electric machine according to claim 1, wherein
the adjacent-pole-connection same layer connection portion is arranged on the outermost radial side and the innermost radial side of the slot.

7. The rotary electric machine according to claim 1, wherein
a pole coil connection portion that sequentially and electrically connects the pole coils in the continuous-pole coils across the blanks or between the continuous-pole coils
connects a layer of the slot on the outermost radial side and a layer of the slot on the innermost radial side when the number of blanks crossed by the pole coil connection portion is odd, and
connects the layers of the slot on the outermost radial side with each other or the layers of the slot on the innermost radial side with each other when the number of blanks crossed by the pole coil connection portion is even (not including zero).

8. The rotary electric machine according to claim 1, wherein
the segment conductor includes
a pair of coil sides accommodated in the two slots, and
one turn coil end that electrically connects the pair of coil sides and is arranged at a coil end, and
the turn coil end of the pole coil is configured, in the a-lap direction ((a+1)-lap direction when a=0), at a short-section pitch of being inclined or bent by one layer from an outer radial side to an inner radial side of the slot.
